(19) United States
(12) Patent Application Publication
(10) Pub. No.: US 2005/0203749 A1
(43) Pub. Date: Sep. 15, 2005

(54) Input device

(75) Inventor: Kazuhiko Miyata, Osaka (JP)

Correspondence Address: KEATING & BENNETT, LLP, 10400 EATON PLACE, SUITE 312, FAIRFAX, VA, 22030, US

(73) Assignee: SHARP KABUSHIKI KAISHA

(21) Appl. No.: 11/065,586

(22) Filed: Feb. 24, 2005

(30) Foreign Application Priority Data
Mar. 1, 2004 (JP) 2004-056602

(51) Int. Cl. G10L 11/00

(52) U.S. Cl. 704/275

(57) ABSTRACT

Information inputted by voice is converted into an audio signal by a sound picking section, and the audio signal is outputted from an audio signal output section. Also, the audio signal is fed back by a local feedback section and is subjected to voice recognition by a voice recognition section so as to be converted into a character code. The character code is converted into a font by a font conversion section so as to be displayed on a display section. This makes it possible to provide an input device, such as a microphone device with a local feedback capability, which makes it possible to easily check for accuracy of an input on the spot upon inputting.

This Nonprovisional application claims priority under 35 U.S.C. § 119(a) on Patent Application No. 056602/2004 filed in Japan on Mar. 1, 2004, the entire contents of which are hereby incorporated by reference.

### FIELD OF THE INVENTION

The present invention relates to an input device such as a microphone device which converts a voice into an electrical signal for output and a coordinate information detection-type input device which generates a change in an electrical potential and in a current according to a position indicated by a touch of a pen or a finger and outputs the change as an electrical signal.

### BACKGROUND OF THE INVENTION

Conventionally, a microphone device has been used which converts a voice into an electrical signal so as to output an audio signal serving as the electrical signal. The audio signal from the microphone device is supplied via a wire or wirelessly to an external device serving as a device which receives an audio signal.

For example, Japanese Laid-Open Patent Publication No. 95322/1989 (Tokukaihei 1-95322; published on Apr. 13, 1989) (Document 1) and Japanese Laid-Open Patent Publication No. 155430/1989 (Tokukaihei 1-155430; published on Jun. 19, 1989) (Document 2) describe an arrangement in which an audio signal from a microphone is supplied into a voice recognition device. Document 1 discloses that information converted into character information by a voice recognition device is displayed on a display device of a computer connected to the voice recognition device. In addition, Document 2 discloses an arrangement in which an image of a microphone and a speaker (here meaning a person who speaks) is captured, and the captured image is subjected to image processing for detection of a positional relationship between the microphone and the speaker's mouth, and the speaker is given a message according to a detection result, so that a voice is reliably supplied to a voice recognition device.

In addition, a coordinate information detection-type input device such as a touch panel has been used conventionally which, on the basis of a change in an electrical potential and in a current generated according to a position indicated by a touch of a pen or a finger, can sequentially detect coordinate information on the indicated position. For example, as disclosed in Japanese Laid-Open Patent Publication No. 347807/2000 (Tokukai 2000-347807; published on Dec. 15, 2000), Japanese Laid-Open Patent Publication No. 131951/1989 (Tokukaihei 1-131951; published on May 24, 1989), and Japanese Laid-Open Patent Publication No. 120258/1993 (Tokukaihei 5-120258; May 18, 1993), an electrical signal outputted from such a coordinate information detection-type input device is supplied to an external device, such as a computer terminal, which receives an electrical signal, and is displayed in a form of a character and the like on a display section or the like of the external device.

However, according the arrangement of the conventional input device, in either case of the microphone device or the coordinate information detection-type input device, input information cannot be checked until the information is sent to an external device for receiving information and then is displayed on a display section of the external device.

Therefore, for example, when an input device is a wireless microphone device, provided with a wireless system, which enables communications with an entity at a place tens of meters away, a user who has inputted a voice by using the microphone device had to move a distance of several meters so as to view the display section of the external device and check on whether the input has been done reliably, thereby making it impossible to easily check for accuracy of the input on the spot upon inputting. Also, with a recent advance of information technology, there is an increasing demand for a device controlled by voice. Particularly, in such an apparatus, it mostly depends on a user's skill in the system to obtain an indicator of whether a speech is loud enough for the apparatus to respond or whether a speech is accurate enough for the apparatus to respond. Thus, there has been no way of knowing on the side of an input device of a simple loudspeaker system whether the input has been done properly.

The same applies to a coordinate information detection-type input device equipped with a wireless system. In addition, the same applies also to a wired system in case of an input to a distant external device.

In addition, also in case of short-distance connection such as connection between an electronic plotter such as a CAD and an input tablet, it has been impossible, when a failure occurs in which an input is not reflected to a final information utilization system, to obtain an easy, quick judgment indicator to judge whether the information is not outputted due to a problem with the side of an input device or the side of an external device (external device).

In recent years, with development of network infrastructures and network services, there has been a demand for a microphone device and a coordinate information detection-type input device, as a single apparatus or device, ensuring their portability and increasing the range of their use and application, by taking the form of a client, particularly called thin client, in which the function of performing main information processing is not always integrated or provided as one system, it is separated from an external apparatus (external device) as a host, and connection to a particular or non-particular host is possible.

Moreover, in case of a touch panel, for example, the user would work on the touch panel while performing a visually unconscious check on whether he/she operates it properly, relying on his/her perception of position in space. This check, however, is a self-performed check with the same sense organs, which cannot exclude the possibility that errors occurred due to illusions and errors occurred due to lowered concentration and nerves accustomed to the stimulus during a continuous operation increase over time.

### SUMMARY OF THE INVENTION

An object of the present invention is to provide an input device with a local feedback function which makes it possible to easily check for accuracy of an input on the spot upon inputting.

In order to achieve the above object, an input device of the present invention is an input device for supplying a signal (e.g., an electrical signal and an optical signal) corresponding to input information, which is inputted from an input section, from a signal output section to an external device connected to the input device, the input device including: local feedback section for feeding back the input information so as to provide a display or output of a voice.

According to this arrangement, input information inputted from the input section is not only converted into an electrical signal or the like so as to be sent to the external device, but also is fed back by the local feedback section so as to be provided as a display or output of a voice. This enables a user to see a display or hear a voice so as to check input information upon inputting.

Therefore, even when an electrical signal cannot be normally sent to the external device due to, for example, input in a low voice in case of a voice input, it becomes possible to grasp the situation on the spot. Improving an input condition by, for example, speaking louder makes it possible to input information reliably and perform input operation at ease all the time. From the presence or absence of a feedback signal (a signal as a feedback derived from input information), it can be judged whether the input device is normally operating. This also serves as a self-check of the function when the input device is the above-mentioned thin client connected at all times to the host.

Also, in case of grasping a state of a voice input from a display, checking can be performed with sense organs different from those used at the time of input, thereby lowering an input error and improving reliability.

In order to achieve the above object, another input device of the present invention is an input device, provided with a coordinate information detection section for detecting a pointed object in contact or standing close so as to sequentially obtain coordinate information on a pointed position, for supplying input information which is inputted by means of the coordinate information detection section, to a first external device connected to the input device, the input device including: local feedback section for feeding back the input information so as to provide output of a voice.

According to this arrangement, in an input device such as a coordinate information detection-type input device, provided with a coordinate information detection device which converts input information supplied using the coordinate information detection device into an electrical signal so as to send the electrical signal to the first external device, wherein the input information supplied using the coordinate information detection device is fed back by the local feedback section so as to be outputted as a voice. Therefore, as in the above arrangement, the user can check the input information upon inputting.

Moreover, at the time of input using the coordinate information detection section, a voice outputted as a feedback on the basis of input information is checked in the ears, which are sense organs irrelevant to input from the coordinate information detection section. Therefore, this checking allows a user to easily perceive feedback information based on the input from the coordinate information detection section, thereby enabling more effective checking, as compared with checking of a display with eyes, i.e., sense organs relevant to the input.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a functional block diagram showing a functional arrangement of a microphone device according to the First Embodiment of the present invention.

FIG. 2 is an explanatory drawing showing appearance and an active state of the microphone device of FIG. 1.

FIG. 3 is a view showing an entire system constituted of the microphone device of FIG. 1 and an external device.

FIG. 4 is a view showing another entire system constituted of the microphone device of FIG. 1 and external devices.

FIG. 5 is a drawing showing a still another entire system constituted of the microphone device of FIG. 1 and an external device.

FIG. 6 is a functional block diagram showing a functional arrangement of a microphone device according to the Second Embodiment of the present invention.

FIG. 7 is a functional block diagram showing a functional arrangement of a microphone device according to Third Embodiment of the present invention.

FIG. 8 is a functional block diagram showing a functional arrangement of a coordinate information detection-type input device according to Fourth Embodiment of the present invention.

FIG. 9 is a functional block diagram showing a functional arrangement of a coordinate information detection-type input device according to the Fifth Embodiment of the present invention.

FIG. 10 is a functional block diagram showing a functional arrangement of a coordinate information detection-type input device according to the Sixth Embodiment of the present invention.

FIG. 11 is a functional block diagram showing a functional arrangement of a coordinate information detection-type input device according to the Seventh Embodiment of the present invention.

FIG. 12 is a block diagram showing one example of a structure which concretely realizes the microphone device of FIG. 1, wherein a substrate, including a display section formed thereon, is provided with a display-section drive circuit, each circuit section of a microphone section and a local feedback section, an audio signal output section of the microphone section, and a by-product data signal output section.

FIG. 13 is a block diagram showing another example of the structure which concretely realizes the microphone device of FIG. 1, wherein the substrate, including the display section formed thereon, is provided with the display-section drive circuit, each circuit section of the microphone section and the local feedback section, the audio signal output section of the microphone section, the by-product data signal output section, and a sound picking section of the microphone section.

FIG. 14 is a block diagram showing a first example of a structure which concretely realizes the microphone device of FIG. 2, wherein a substrate, including a display section formed thereon, is provided with a display-section drive circuit, each circuit section of a microphone section and a local feedback section, an audio signal output section of the microphone section, a by-product data signal output section, and a sound picking section of the microphone section, and a sound producing section of the local feedback section is formed separately from the substrate.

FIG. 15 is a block diagram showing a second example of the structure which concretely realizes the microphone device of FIG. 2, wherein the substrate, including the display section formed thereon, is provided with the display-section drive circuit, each circuit section of the microphone section and the local feedback section, the audio signal output section of the microphone section, the by-product data signal output section, and the sound producing section of the local feedback section, and the sound picking section of the microphone section is formed separately from the substrate.

FIG. 16 is a block diagram showing a third example of the structure specifically realizing the microphone device of FIG. 2, wherein the substrate, including the display section formed thereon, is provided with the display-section drive circuit, each circuit section of the microphone section and the local feedback section, the audio signal output section of the microphone section, the by-product data signal output section, the sound-producing section of the local feedback section, and the sound picking section of the microphone section.

FIG. 17 is a block diagram showing a fourth example of the structure which concretely realizes the microphone device of FIG. 2, wherein the substrate, including the display section formed thereon, is provided with the display-section drive circuit, each circuit section of the microphone section and the local feedback section, the audio signal output section of the microphone section, the by-product data signal output section, and a sound source section used as both the sound producing section of the local feedback section and the sound picking section of the microphone section.

FIG. 18 is a block diagram showing one example of a structure which concretely realizes the coordinate information detection-type input device of FIG. 10, wherein a substrate, including a display section formed thereon, is provided with a display-section drive circuit, each circuit section of a local feedback section, a video signal output section of a touch panel section, and a by-product data signal output section.

FIG. 19 is a block diagram showing one example of a structure which concretely realizes the coordinate information detection-type input device of FIG. 11, wherein a substrate, including a display section formed thereon, is provided with a display-section drive circuit, each circuit section of a local feedback section, a video signal output section of a touch panel section, and a by-product data signal output section, and a sound producing section of the local feedback section is formed separately from the substrate.

FIG. 20 is a block diagram showing another example of the structure which concretely realizes the coordinate information detection-type input device of FIG. 11, wherein the substrate, including the display section formed thereon, is provided with the display-section drive circuit, each circuit section of the local feedback section, the video signal output section of the touch panel section, the by-product data signal output section, and the sound producing section of the local feedback section.

### DESCRIPTION OF THE EMBODIMENTS

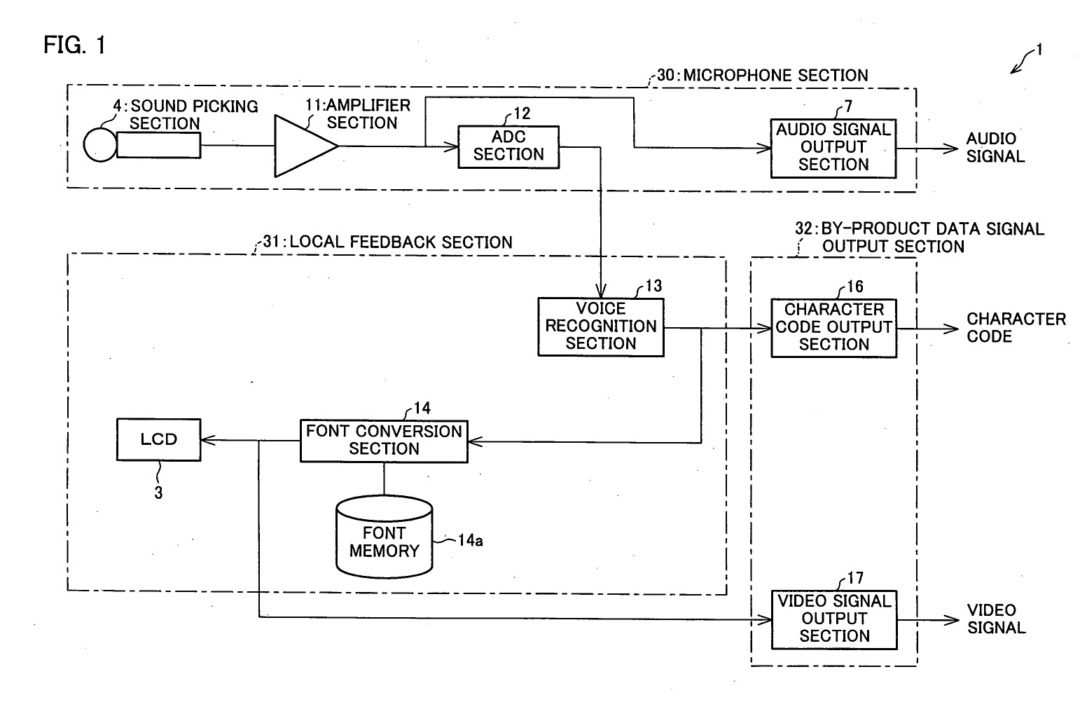

The embodiments of the present invention will be described below in reference to FIGS. 1 to 20.

[First Embodiment]

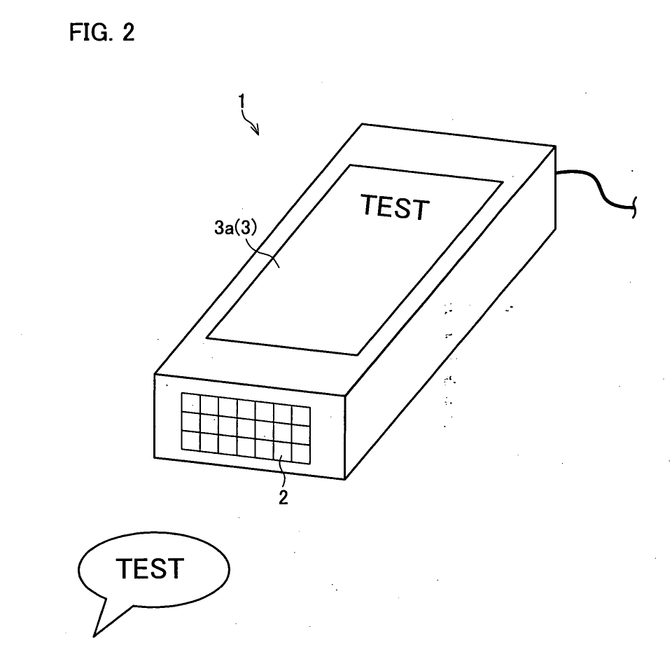

FIG. 2 is an outline view of a microphone device 1 according to the First Embodiment of the present invention. As shown in FIG. 2, in terms of its appearance, the microphone device 1, provided with a sound collecting hole 2, takes the form of a microphone device which a user can hold with one or both hands for use. Basically, the microphone device 1 differs in outer appearance from a conventional microphone device in that the microphone device 1 has a display section 3, and is not limited in outer appearance to the conventional microphone device.

It is to be noted that the microphone device 1 does not necessarily need to be thin rectangle in shape shown in FIG. 2. However, for the necessity of mounting the display section 3 on the microphone device 1, it is preferable the microphone device 1 is cuboid in shape, for example, since a cylindrical microphone device cannot ensure a wide space for a flat display section.

A display element constituting the display section 3 only needs to be a display section which can be driven by a thin film element formed of a thin film layer. The display element may be an LCD; an EL (electro luminescence) element; an element which makes a display by changing a state of diffusion or scattering of an incoming beam by using a piezoelectric element, a micromachine, or the like to control a movable pixel section; or an element which adopts an FED (field emission display) scheme.

FIG. 1 is a functional block diagram showing a functional arrangement of such a microphone device. As shown in FIG. 1, the microphone device 1 according to the first embodiment is mainly composed of a microphone section 30, a local feedback section 31, and a by-product data signal output section 32.

The microphone section 30, which is an essential function part of a microphone device, converts an inputted voice into an electrical signal so as to output the electrical signal as an audio signal. Specifically, the microphone section 30 includes a sound picking section 4, an amplifier section 11, an analog-digital converter (ADC) section 12, and an audio signal output section 7.

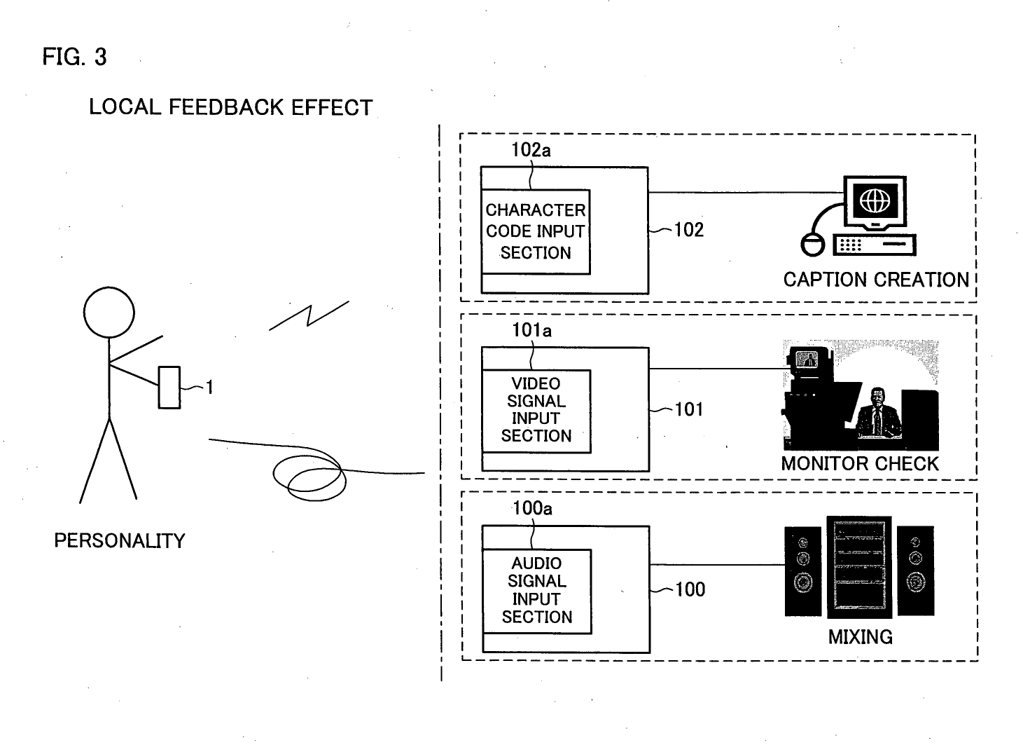

The sound picking section 4 converts a voice, taken in from the sound collecting hole 2, into an electrical signal so as to output the electrical signal. The electrical signal is supplied to the amplifier section 11 and then amplified by the amplifier section 11. Thereafter, the amplified electrical signal is supplied to the audio signal output section 7 and then outputted to an external device 100 (see FIG. 3), to be mentioned later, serving as a device which receives an audio signal.

The local feedback section 31 performs voice recognition to the audio signal, which is output from the audio signal output section 7 of the microphone section 30, converts the audio signal into a font on the basis of the voice recognition result so as to display the font. Specifically, the local feedback section 31 includes a voice recognition section 13, a font conversion section 14, a font memory 14a, and the display section (LCD) 3.

The voice recognition section 13 recognizes an inputted audio signal and outputs a character code corresponding to the inputted audio signal. The voice recognition section 13 converts an audio signal supplied from the ADC section 12 of the microphone section 30 into a character code and then outputs the character code to the font conversion section 14. The font conversion section 14 converts the character code supplied from the voice recognition section 13 into its corresponding font data selected from among sets of font data stored in the font memory 14a. The font conversion section 14 converts a character code into font data and then sent the font data as a video signal to the display section 3. The display section 3 displays a font based on the supplied video signal.

The by-product data signal output section 32 makes it possible to output to an external entity a character code or a video signal generated in the local feedback section 31. For this purpose, the by-product data signal output section 32 includes a character code output section 16 and a video signal output section 17. It is to be noted that the by-product data signal output section 32 may be arranged to be provided with any one of the character code output section 16 and the video signal output section 17.

The character code output section 16 outputs a character code supplied from the voice recognition section 13, to an external device, to be mentioned later, serving as a device which receives a character code. The video signal output section 17 outputs a video signal supplied from the font conversion section 14, to an external device, to be mentioned later, serving as a device which receives a video signal.

In the microphone device 1 according to such an arrangement, when a user speaks the word /TEST/, for example, the spoken word is converted into an audio signal by the microphone section 30, and the audio signal is then outputted from the audio signal output section 7. Meanwhile, the audio signal is subjected to voice recognition by the local feedback section 31 and then converted into a font for display on the display section 3 as a feedback. For example, if there is no problem with the volume of an input voice or the like, the spoken word /TEST/ is displayed in its corresponding font. On the contrary, in case of a small or unclear voice, nothing is displayed on the display section 3, or a wrong content is displayed in the font.

With the use of the microphone device 1, the user can easily check for accuracy of the input upon inputting. If there is no problem, the user can continue the input. If there is a problem, the user can take such measures as speaking louder and pronouncing a word more clearly. This enables the user to input information reliably without feeling uneasy about an input condition.

Moreover, the checking for accuracy of the input here is a checking such that a displayed feedback information of a voice input is checked with the user's eyes, which are sense organs irrelevant to sound. Therefore, as compared with a checking for accuracy of a voice output in the user's ears, which are sense organs relevant to sound, the checking with the eyes becomes easier for the user to perceive the content of feedback information, thereby enabling more effective checking.

From the presence or absence of a feedback signal (a signal as a feedback derived from input information), it can be judged whether the microphone device 1 serving as an input device is normally operating. This also serves as a self-check of the function of the microphone device 1 when the microphone device 1 is the above-mentioned thin client connected at all times to the host.

Moreover, in this case, adjustment to an algorithm and a parameter applied in the voice recognition section 13 makes it possible to adjust the amount of feedback which becomes a criterion for determination of an input level required in an external device.

In addition, the microphone device 1 according to the above arrangement is further provided with the by-product data signal output section 32 for outputting a character code and a video signal generated by the local feedback section 31 to an external entity. With this arrangement, connection of the character code output section 16 or the video signal output section 17 in the by-product data signal output section 32 to an external device allows for output of a character code or a video signal as a feedback.

Therefore, the microphone device 1 is not only a microphone device, but also can be used as a substitutional device for a keyboard for outputting a character code and an imaging device, such as a scanner and a CCD camera, for outputting a video signal. In addition, the microphone device 1 can be used also as a device for outputting an audio signal of a synthetic voice. This causes the microphone device 1 to be a device of high convenience.

It is to be noted, needless to say, that the by-product data signal output section 32, with its local feedback function, contributes to improvement on the convenience of an input device However, the by-product data signal output section 32, not required for a local feedback checking of input information, does not necessarily needed in the microphone device 1. The same applies to all the embodiments to be mentioned later.

FIG. 3 shows an arrangement of an entire system constituted of: the microphone device 1 having the above-described arrangement; an external device 100 which serves as a first external device for receiving an audio signal; and external devices 101 and 102 which serve as second external devices for respectively receiving a video signal and a character code outputted from the by-product data signal output section 32.

When the external device 100 is connected to a device provided with a general microphone socket to be connected via a wire to the microphone device 1 or is connected wirelessly to the microphone device 1, the external device 100 is a base station wireless facility or a receiver constituting a widely used wireless system. In any case, the external device 100 only needs to be provided with an audio signal input section 100a.

In addition, the external device 101 may be a host system or the like which handles information in widely used formats. In any case, the external device 101 only needs to be provided with a video signal input section 101a. Connection between the external device 101 and the microphone device 1 may be wired or wireless connection.

Similarly, the external device 102 may be a host system or the like which handles information in widely used formats. In any case, the external device 102 only needs to be provided with a character-code input section 102a. Connection between the external device 102 and the microphone device 1 may also be wired or wireless connection.

FIG. 3 exemplifies a system in which a personality concurrently carries out input of a voice by means of the microphone device 1, mixing, monitor check, and caption creation.

Voice input information inputted by means of the microphone device 1 is supplied via a wire or wirelessly to the external device 100, which is provided with the audio signal input section 100a, and is subjected to mixing processing or the like. Then, a local feedback result of the voice input information is displayed on the display section 3 of the microphone device 1. The personality keeps his/her operation going while seeing a display on the display section 3 to check a result of the input. In addition, a video signal and a character code, generated as by-products at the time of local feedback (which originate from the same voice input), are supplied to the external devices 101 and 102, respectively. The external device 101 displays the video signal on a separate display device, so that another person uses the display so as to check it on the monitor. In addition, the external device 102 outputs the character code to a caption creation device, and the caption creation device concurrently performs caption creation.

Thus, the microphone device 1 makes it possible to effectively check for accuracy of an input, provide the same information source in a plurality of formats so as to concurrently perform multiple operations, and construct a novel automatic operation system by way of mutual information.

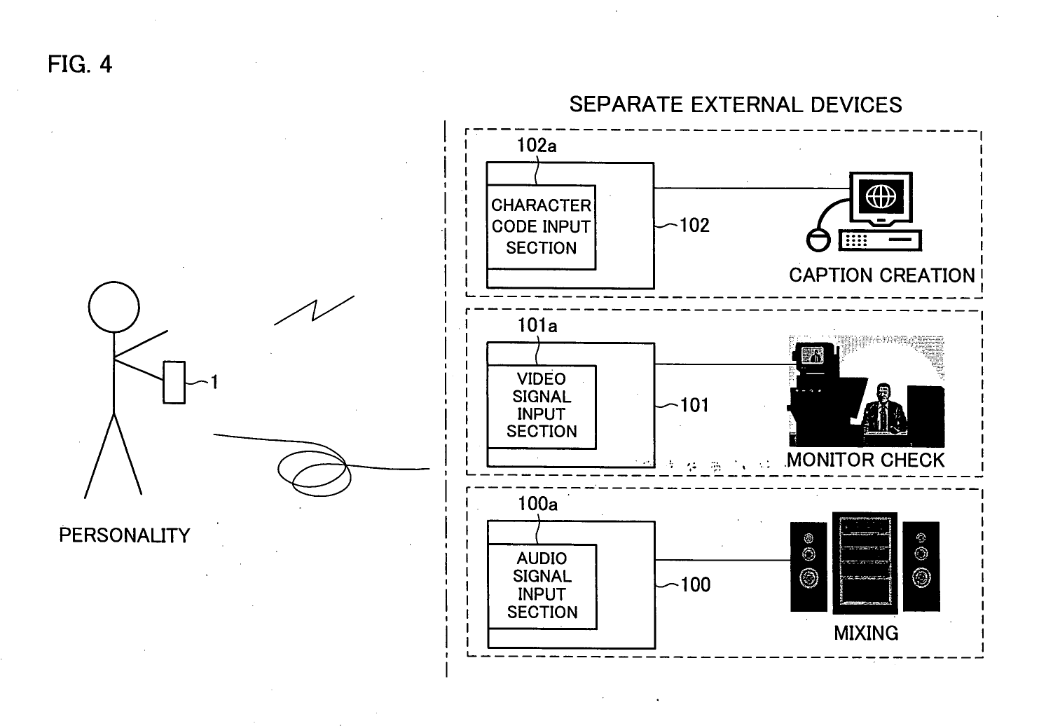

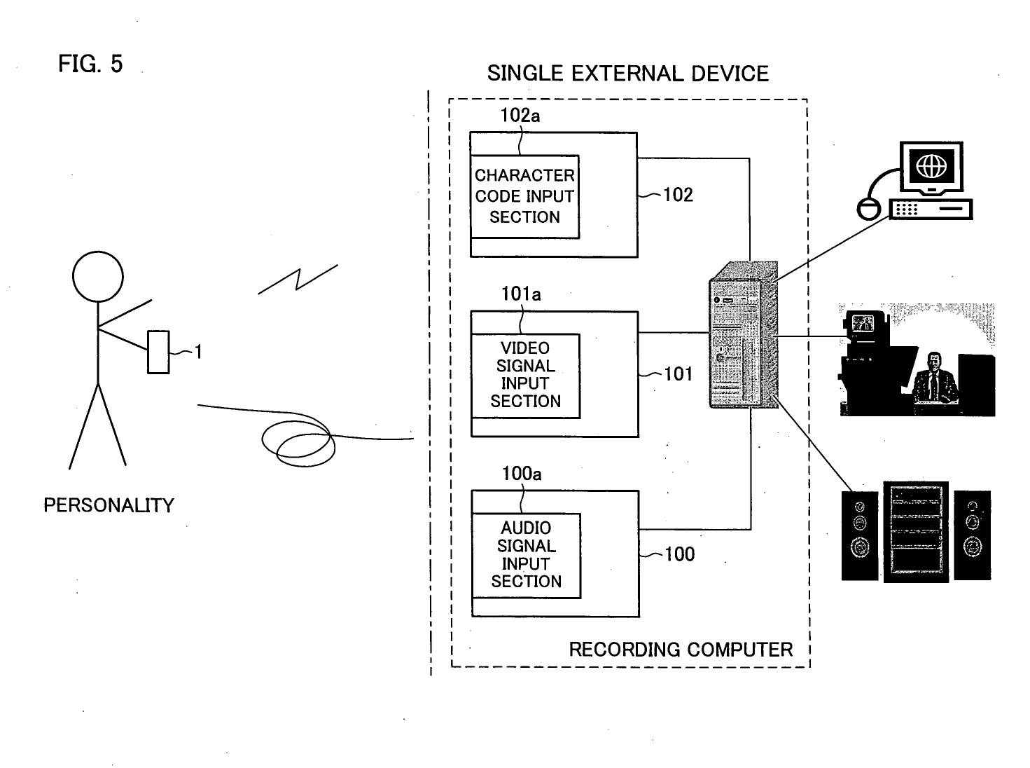

As shown in FIG. 4, the external device 100, serving as the first external device, and the external devices 101 and 102, serving as the second external device, may be constituted of separate external devices. Also, as shown in FIG. 5, the external device 100 and the external devices 101 and 102 may be included all in a single external device (recording computer). When the external device 100 and the external devices 101 and 102 are separate, as shown in FIG. 4, it becomes possible to obtain information in a simple manner simultaneously among different jobs. In addition, the external device 100 and the external devices 101 and 102 included in a single external device, as shown in FIG. 5, contribute to expanding application of the single external device and improving information reliability.

Also, in this case, the microphone device 1 does not necessarily need to be connected to the external device 100, serving as the first external device, so as to function. The microphone device 1 can be used also by being connected only to the external devices 101 and 102, serving as the second external device.

[Second Embodiment]

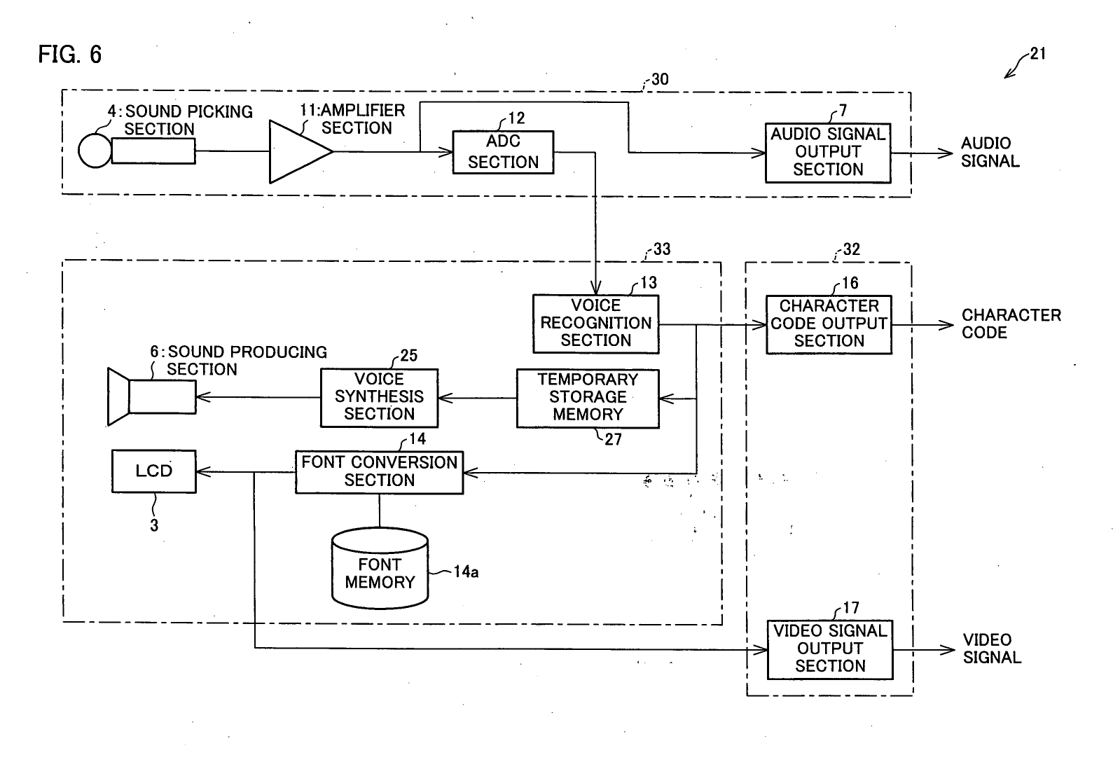

The following will describe a microphone device 21 according to the Second Embodiment of the present invention with reference to FIG. 6. It is to be noted, for the sake of convenience, that components having the same functions as those described in the First Embodiment are given the same reference numerals, and explanations thereof are omitted here.

The microphone device 21 according to the Second embodiment is identical in appearance to the microphone device 1 (see FIG. 2) according to the First Embodiment. The microphone device 21, having a display device 3, thoroughly takes the form of a microphone which a user can hold with one or both hands for use.

As shown in FIG. 6, the microphone device 21 according to the Second Embodiment differs from the microphone device 1 only in that the microphone device 21 is provided with a local feedback section 33 instead of the local feedback section 31.

The local feedback section 31 in the microphone device 1 according to the First Embodiment performs voice recognition to an audio signal of an input voice and then converts the character code obtained by the voice recognition of the audio signal into a font so as to display the font on the display section 3. On the contrary, the local feedback section 33 in the microphone device 21 according to the Second Embodiment, in addition to making a display using the display section 3, is arranged to output a voice recognition result as a voice from a sound producing section 6.

Specifically, the local feedback section 33 is provided with a temporary storage memory 27, a voice synthesis section 25, and the sound producing section 6, in addition to the voice recognition section 13, the font conversion section 14, and the display section 3.

A character code output of the voice recognition section 13 is supplied not only to the font conversion section 14 but also to the voice synthesis section 25 through the temporary storage memory 27. The voice synthesis section 25 is, in order to output from the sound producing section 6 a voice corresponding to an inputted character code, extracts from a voice data memory (not shown) a piece of voice data corresponding to the character code so as to perform a suitable connection editing. The voice data memory is dispensable if the voice synthesis section 25 can be realized only by speech synthesis by rule by voice-production mechanism modeling.

The character code supplied from the voice recognition section 13 is converted into audio data as an audio signal by the voice synthesis section 25, and the audio data is outputted as a voice from the sound producing section 6. This makes it possible for a user to check a voice as well as a display for accuracy of an input upon inputting. In this arrangement, the user can check for accuracy of an input more effectively than checking of a display alone.

It is to be noted, as described above, that since checking for accuracy of the input is possible by only a voice output from the sound producing section 6, the present invention may be arranged such that only a voice is outputted as a feedback from the sound producing section 6 without provision of the display section 3 or without displaying a font on the display section 3.

The temporary storage memory 27 is timing adjustment means inserted so as to change timings between voice input from the sound picking section 4 and voice output from the sound producing section 6. In some cases, a synthetic voice which has been picked by the sound picking section 4, amplified by the amplifier section 11, and then emitted from the sound producing section 6, is picked again by the sound picking section 4, so that a very unpleasant and loud noise is outputted as howling due to endless passages through an amplifier circuit and an effect of transmission distortion and delay. The temporary storage memory 27 delays timing of a voice output, so that an effect of preventing howling can be expected.

Also, a person stops speaking or feels hesitant to speak when his or her own voice is reflected back after some delay. In view of this, an arrangement in which the temporary storage memory 27, storing character codes, is inserted so that the character code is outputted as a voice in response to a reproduction instruction allows the microphone device 21 to avoid the problem that the user (speaker) hesitates to speak or the like problem. Also, the result of the input can be recorded so as to be reproduced whenever necessary. The temporary storage memory 27 may be of a simple arrangement realized by a simple ring buffer which continuously performs input and output at the same speed, thereby causing a delay by a buffer length. The temporary storage memory 27 may also be provided with an advanced control function of detecting silence so as to output information stored in a memory. Also, the temporary storage memory 27 may be disposed behind the voice synthesis section 25.

[Third Embodiment]

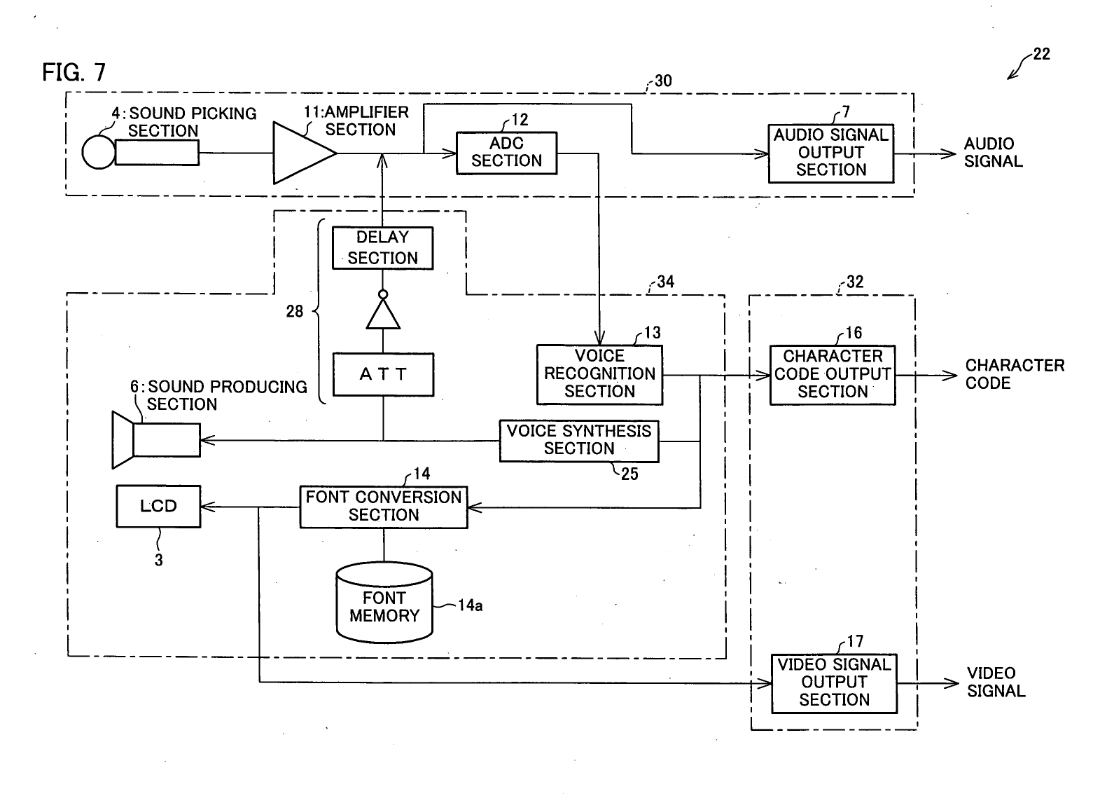

The following will describe a microphone device 22 according to the Third Embodiment of the present invention with reference to FIG. 7. It is to be noted, for the sake of convenience, that components having the same functions as those described in the First and Second Embodiments are given the same reference numerals, and explanations thereof are omitted here.

As shown in FIG. 7, the microphone device 22 according to the Third Embodiment differs from the microphone device 21 according to the Second Embodiment in that the microphone device 22 is provided with a local feedback section 34 instead of the local feedback section 33.

The local feedback section 33 in the microphone device 21 according to the Second Embodiment causes the temporary storage memory 27 to adjust timing between a voice input and a voice output when performing voice recognition to an audio signal of an inputted voice and outputting the voice from the sound producing section 6. On the contrary, the local feedback section 34 in the microphone device 22 according to the present embodiment differs from the local feedback section 33 only in that the local feedback section 34 is provided with an echo cancellation circuit 28 instead of the temporary storage memory 27.

The echo cancellation circuit 28 is composed of: (i) an attenuator (ATT) circuit for lowering an audio signal supplied from the voice synthesis section 25 to a predetermined level, or a buffer amplifier circuit for amplifying an audio signal supplied from the voice synthesis section 25 to a predetermined level; (ii) an inverter for reversing a phase of an audio signal; and (iii) a delay section for giving an audio signal a delay corresponding to a period during which a voice outputted from the sound producing section 6 is inputted to the sound picking section 4. The echo cancellation circuit 28 cancels an audio portion, included in a voice inputted from the sound picking section 4, which has been outputted from the sound producing section 6. The provision of the echo cancellation circuit 28 prevents howling even when a voice input to the sound picking section 4 and a voice output from the sound producing section 6 concur.

In addition, the present invention may be arranged such that a PTT (push to talk) switch, a VOX (voice operated transfer) circuit, or the like, in addition to the echo cancellation circuit 28 is provided so as to enable unilateral (simplex) operation when speech is made for input of a voice to the sound picking section 4. The PTT switch is a switch for causing a microphone circuit to operate only at the time of speaking. The VOX circuit causes the microphone circuit to automatically operate if an audio signal is inputted at or above a predetermined level assuming that speech has been made near a microphone.

[Fourth Embodiment]

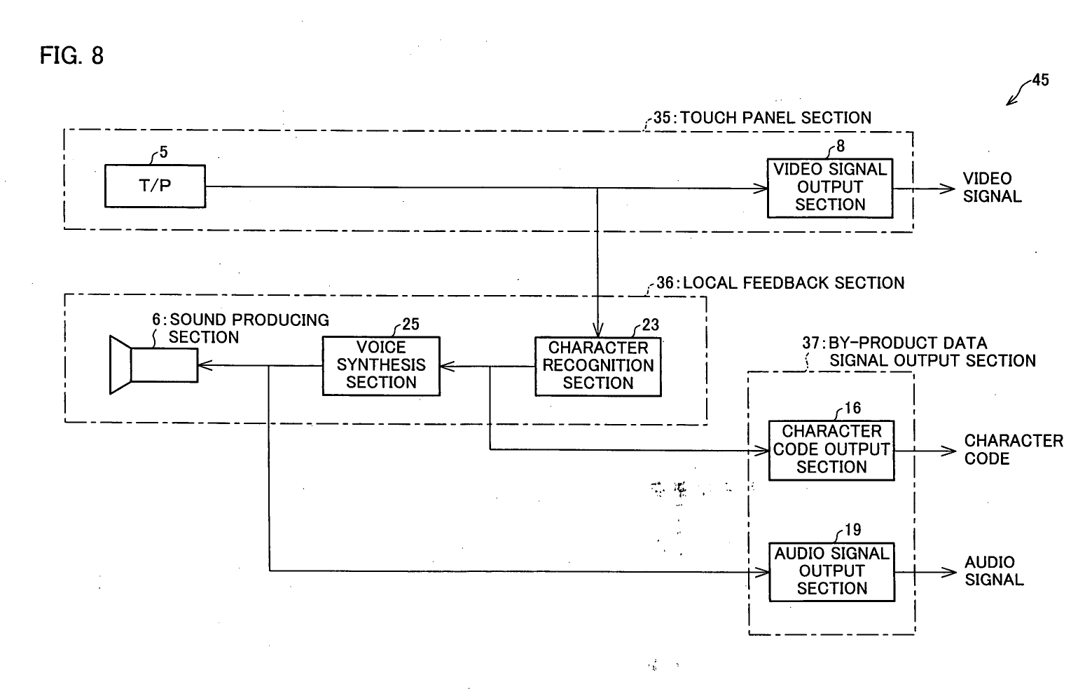

The following will describe a coordinate information detection-type input device 45 according to Fourth Embodiment of the present invention with reference to FIG. 8. It is to be noted, for the sake of convenience, that components having the same functions as those described in the First to Third Embodiments are given the same reference numerals, and explanations thereof are omitted here.

FIG. 8 is a block diagram showing a configuration of the coordinate information detection-type input device 45 according to the present embodiment. As shown in FIG. 8, the coordinate information detection-type input device 45 is composed mainly of a touch panel section (coordinate information detection section) 35, a local feedback 36, and a by-product data signal output section 37.

The touch panel section 35, which is an essential function part of a coordinate information detection-type input device, converts information inputted by means of a touch panel 5 into an electrical signal so as to output the electrical signal as a video signal. Specifically, the touch panel section 35 includes a touch panel (T/P) 5 and a video signal output section 8.

The touch panel 5 gives a source signal for identifying coordinates of a contact point (i.e. a point touched by a pen or a hand) by detecting fluctuations of a flowing current and a voltage on the basis of a change in a load generated at the contact point on a surface of the touch panel 5. That is, the touch panel 5 is a device for outputting information on the coordinates of the contact point (coordinate information) as an electrical signal corresponding to the content of an input. At a subsequent stage of the touch panel 5, a signal processing circuit can be provided for performing signal processing so as to output the coordinate information as it is or convert the coordinate information into a video signal. The following will takes, as an example, a case where coordinate information is converted into a video signal and outputted as a video signal. A video signal from the touch panel 5 is supplied to the video signal output section 8 and then outputted from the video signal output section 8 to an external device serving as a device which receives the video signal.

It is to be noted that the touch panel 35 may be arranged so that the touch panel 35 is not provided with the signal processing circuit and the information on the coordinates of the contact point is directly outputted from an output section of the touch panel 5. Also, the touch panel 5 is laminated on the side of a display surface of the display section 3.

The local feedback section 36 performs character recognition with respect to a video signal which has been converted from an entry from the touch panel section 35 and then outputted from the video signal output section 8, and synthesizes a character recognition result so as to output it as a voice. For this purpose, the local feedback section 36 specifically includes a character recognition section 23, a voice synthesis section 25, and a sound producing section 6.

The character recognition section 23, by using a pattern matching technique or the like, carries out matching of information on shape of a character in the video signal outputted from the touch panel 5 for identification of a handwritten character and the like, and converts the handwritten character into its corresponding character code so as to output the character code. Handwritten information, inputted to the touch panel 5, is converted into a character code and then outputted by the character recognition section 23. The converted character code is supplied to the voice synthesis section 25 and then converted into an audio signal as a voice by the voice synthesis section 25. The audio signal is supplied to the sound producing section 6 so as to be outputted as a voice from the sound producing section 6.

The by-product data signal output section 37 makes it possible to output to an external device a character code or an audio signal generated by the local feedback section 36. For this purpose, the by-product data signal output section 37 includes a character code output section 16 and an audio signal output section 19. It is to be noted that although the by-product data signal output section 37 herein is provided with both the character code output section 16 and the audio signal output section 19, the by-product data signal output section 37 may be provided with any one of the output sections.

The character code output section 16 receives a character code from the character recognition section 23 and outputs the character code to an external device serving as a device which receives a character code. The audio signal output section 19 receives an audio signal from the voice synthesis section 25 and outputs the audio signal to an external device serving as a device which receives an audio signal.

In the coordinate information detection-type input device 45 of such an arrangement, when a user inputs the word, for example, /TEST/ by handwriting on the touch panel 5, the handwritten character information is converted directly into a video signal by the touch panel section 35, and the video signal is outputted from the video signal output section 8. Also, by the local feedback section 36, the video signal is subjected to character recognition and voice synthesis in this order so that a voice is outputted as a feedback to the sound producing section 6.

For example, if there is no problem with the handwritten input, the handwritten word /TEST/ is outputted as its corresponding voice. However, a character written with low writing pressure and a character written in cursive style are beyond recognition. As a result, nothing is outputted as a voice output, or such characters are recognized as different characters, so that a voice whose content is different from that of the input is outputted.

Therefore, the coordinate information detection-type input device 45 enables the user to easily check for accuracy of an input on the spot upon inputting. If there is no problem, the user can continue the input. If there is a problem, the user can take such measures as adjusting writing pressure and character style. This enables the user to input or provide information reliably without feeling uneasy about an input condition.

Moreover, the checking for accuracy of the input here is a checking such that a voice outputted as feedback information derived from a handwritten input on the touch panel 5 is checked in ears, which are sense organs irrelevant to handwriting input. Therefore, as compared with a checking of the handwritten input with eyes, which are sense organs relevant to the handwritten input, the checking in the ears becomes easier for a user to perceive the content of feedback information, thereby enabling more effective checking.

In addition, the coordinate information detection-type input device 45 according to the above arrangement is further provided with the by-product data signal output section 37 for outputting, to an external device, a character code and an audio signal generated in the local feedback section 36. With this arrangement, connection of the character code output section 16 or the audio signal output section 19 in the by-product data signal output section 37 to an external device allows for output of a character code or a video signal as a feedback.

Therefore, the coordinate information detection-type input device 45 is not only a coordinate information detection-type input device, but also can be used as a substitutional device for various devices including a keyboard for outputting a character code and an imaging device, such as a scanner and a CCD camera, for outputting a video signal. In addition, the coordinate information detection-type input device 45 can be used also as a device (e.g., a vocoder or a text voice synthesizer) for outputting an audio signal of a synthetic voice. This causes the coordinate information detection-type input device 45 to be a device of high convenience.

An arrangement of an entire system constituted of: the coordinate information detection-type input device 45 having the above-described arrangement; and an external device serving as a device which receives a video signal is basically the same as shown in FIGS. 3 to 5. In this case, a first external device constituting the system together with the coordinate information detection-type input device 45 serves as an external device 101, provided with a normal video signal input section 101a which is connected via a wire to the coordinate information detection-type input device 45. When the external device 101 is connected wirelessly to the coordinate information detection-type input device 45, the external device 101 is a base station wireless facility or a receiver constituting a widely used wireless system. In any case, the external device 101 only needs to be provided with the video signal input section 101a.

In addition, second external devices for receiving a character code or an audio signal output from the coordinate information detection-type input device 45 having the above-described arrangement serves as external devices 102 and 100. A system for processing a character code or an audio signal only needs to be provided with a character code input section 102a or a video signal input section 101a. Connection between the coordinate information detection-type input device 45 and the external devices 102 and 100 may be wired or wireless connection.

[Fifth Embodiments]

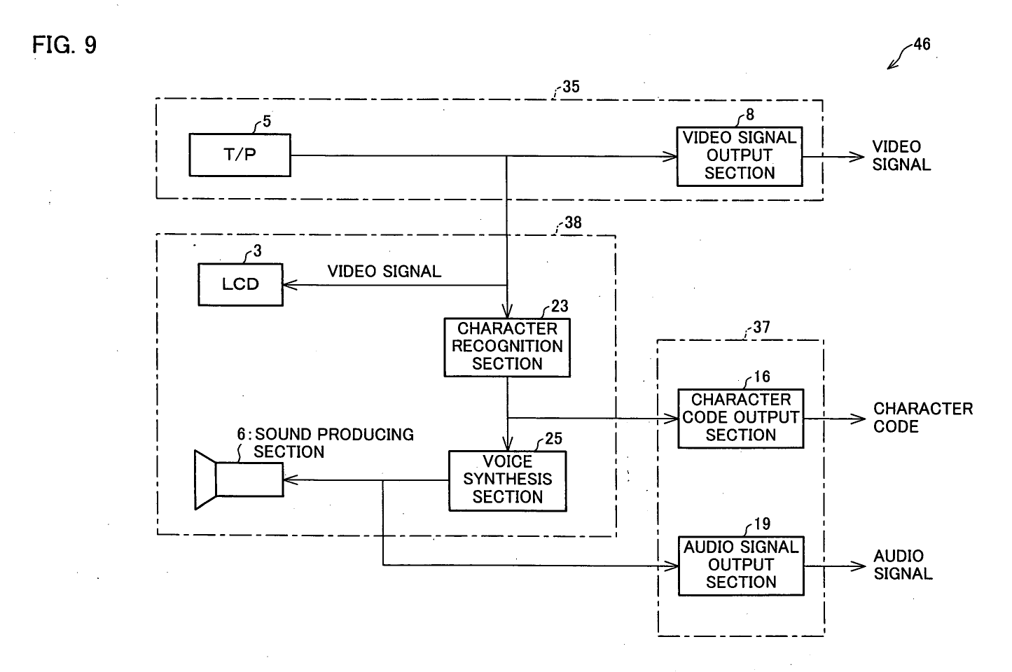

The following will describe a coordinate information detection-type input device 46 according to the Fifth Embodiment of the present invention with reference to FIG. 9. It is to be noted, for the sake of convenience, that components having the same functions as those described in the First to Fourth Embodiments are given the same reference numerals, and explanations thereof are omitted here.

As shown in FIG. 9, a coordinate information detection-type input device 46 according to the present embodiment differs from the coordinate information detection-type input device 45 according to the Fourth Embodiment in that the coordinate information detection-type input device 46 is provided with a local feedback section 38 instead of a local feedback section 36.

The local feedback section 36 in the coordinate information detection-type input device 45 according to the Third Embodiment performs character recognition with respect to a video signal of a character inputted by handwriting to a touch panel 5, performs voice synthesis on the basis of a result of the character recognition, and outputs a voice from the sound producing section 6. On the contrary, the local feedback section 38 in the coordinate information detection-type input device 46 differs only in that the local feedback section 38 uses a display section to display the content of an input, in addition to using the sound producing section 6 to output a voice, thereby enabling visual confirmation.

The local feedback section 38 is provided with the display section 3 in addition to the character recognition section 23, the voice synthesis section 25, and the sound producing section 6. In the local feedback section 38, a video signal supplied from the touch panel 5 is also outputted to the display section 3. The display section 3 displays a character inputted by handwriting as it is.

This makes it possible for a user to check a display as well as a voice for accuracy of an input on the spot upon inputting. In this arrangement, the user can check for accuracy of an input more effectively than checking of a voice alone.

It is to be noted that checking for accuracy of the input is possible by only a direct display of a character inputted by handwriting to the display section 3. Therefore, although the display of a character on the display section 3 is less easy for a user to perceive than a voice output, an arrangement may be adopted in which a handwritten character is only displayed directly.

[Sixth Embodiment]

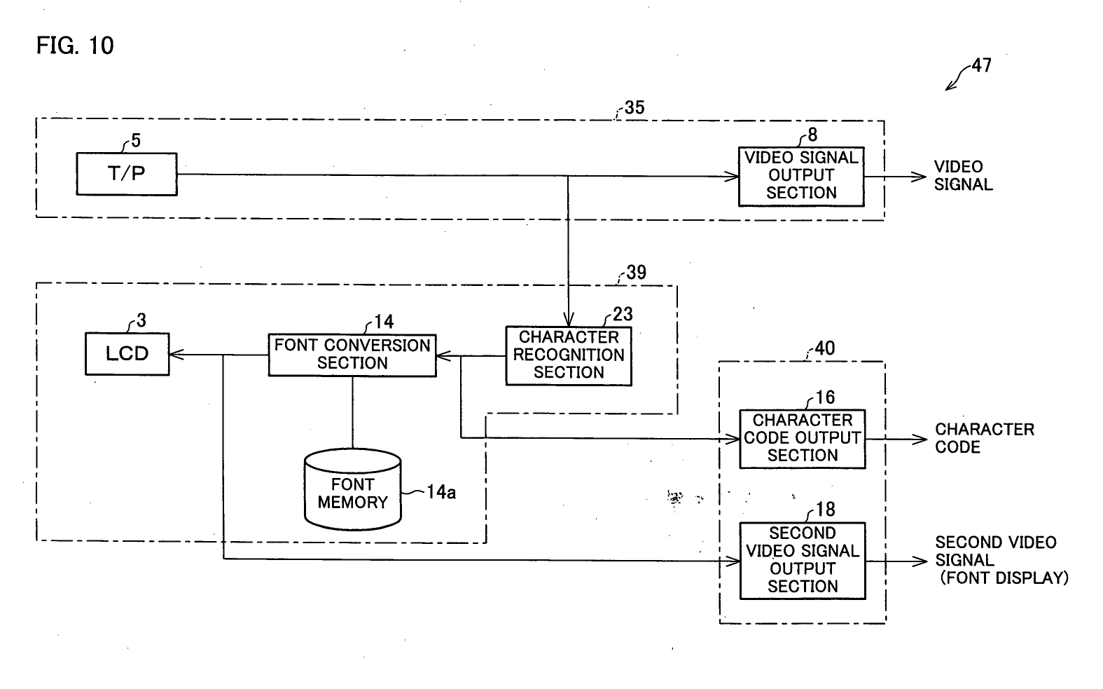

The following will describe a coordinate information detection-type input device 47 according to the Sixth Embodiment of the present invention with reference to FIG. 10. It is to be noted, for the sake of convenience, that components having the same functions as those described in the First to Fifth Embodiments are given the same reference numerals, and explanations thereof are omitted here.

As shown in FIG. 10, a coordinate information detection-type input device 47 according to the present invention differs from the coordinate information detection-type input device 45 according to the Fourth Embodiment in that the coordinate information detection-type input device 47 is provided with a local feedback section 39 instead of the local feedback section 36, and also in that the coordinate information detection-type input device 47 is provided with a by-product data signal output section 40 instead of the by-product data signal output section 37.

The local feedback section 36 in the coordinate information detection-type input device 45 according to the Fourth Embodiment performs character recognition with respect to a video signal of a character inputted by handwriting to the touch panel 5, performs voice synthesis on the basis of a result of the character recognition, and outputs a voice from the sound producing section 6. On the contrary, the local feedback section 39 in the coordinate information detection-type input device 47 performs character recognition with respect to a handwritten character, converts a character code obtained by the character recognition into a font, and displays the font as a feedback on the display section 3.

The local feedback section 39 is provided with the character recognition section 23, the font conversion section 14, the font memory 14a, and the display section 3. A video signal supplied from the touch panel 5 is converted into a character code by the character recognition section 23, converted into a font by the font conversion section 14 by using font data stored in the font memory 14a, and then displayed in a font on the display section 3.

That is, character information inputted by handwriting using the touch panel 5 is not only converted into a video signal by the touch panel section 35 so as to be outputted from the video signal output section 8, but also is subjected to character recognition and then converted into a font by the local feedback section 39 for display on the display section 3 as a feedback. For example, if there is no problem with the handwritten input, the handwritten word /TEST/ is displayed as its corresponding font. However, a character written with low writing pressure and a character written in cursive style are beyond recognition. As a result, nothing is displayed; or such characters are recognized as different characters, so that a display whose content is different from that of the input is outputted.

Therefore, the coordinate information detection-type input device 47 enables a user to easily check for accuracy of an input on the spot upon inputting. If there is no problem, the user can continue the input; if there is a problem, the user can take such measures as adjusting writing pressure and character style. This enables the user to input information reliably without feeling uneasy about an input condition.

In addition, checking of the input here is checking by sight, which is the same sense as used in a handwriting input. However, this checking, which is checking of a font pattern display of the handwritten input, is effective in that the user can recognize a feedback more easily than checking of a direct display of the handwritten input on the display section.

In addition, the by-product data signal output section 40 provided in the coordinate information detection-type input device 47 includes a character code output section 16 and a second video signal output section 18 so as to be able to output out of the coordinate information detection-type input device 47 a character code generated by the local feedback section 39 and a video signal realized by font data, respectively. Therefore, connection of the character code output section 16 or the second video signal output section 18 in the by-product data signal output section 37 to an external device allows for output of a character code and a video signal realized by font data as a feedback.

Therefore, the coordinate information detection-type input device 47 is not only a coordinate information detection-type input device, but also can be used as a keyboard for outputting a character code or a device such as a rewriting machine for outputting a video signal realized by font data. This causes the coordinate information detection-type input device 47 to be a device of high convenience. It is to be noted that, according to the above descriptions, although the by-product data signal output section 40 in the coordinate information detection-type input device 47 includes both the character code output section 16 and the second video signal output section 18, the by-product data signal output section 40 may be provided with any one of the output sections.

[Seventh Embodiment]

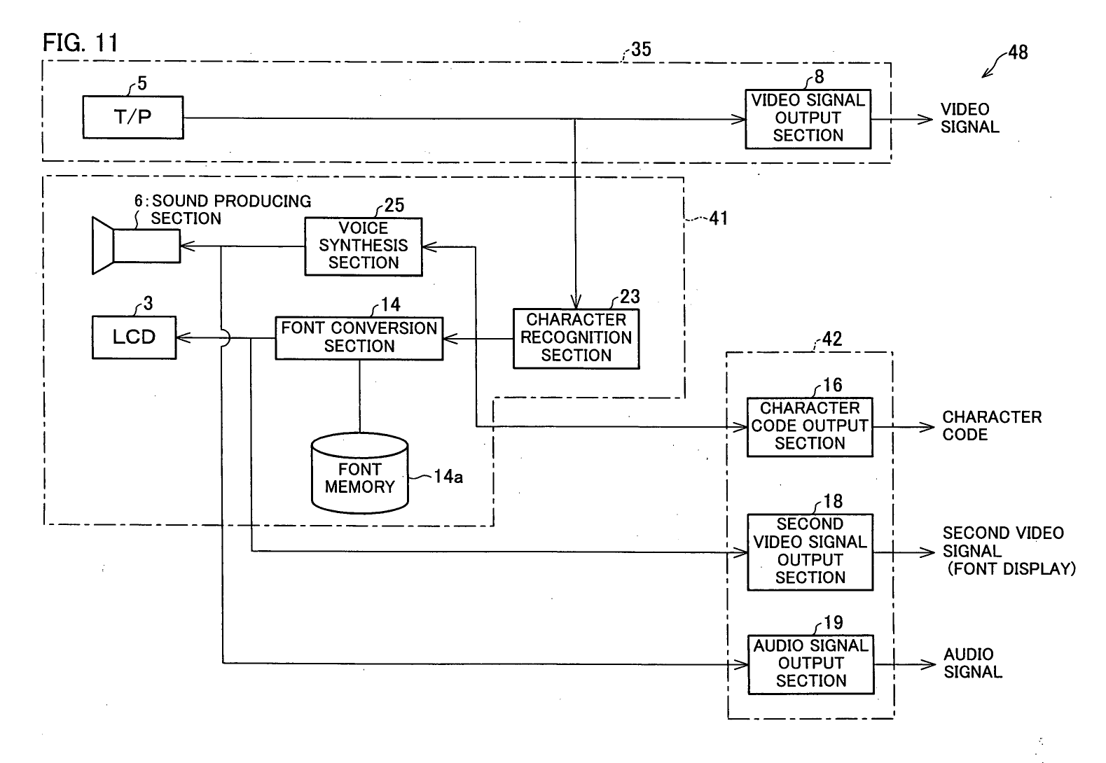

The following will describe a coordinate information detection-type input device 48 according to the Seventh Embodiment of the present invention with reference to FIG. 11. It is to be noted, for the sake of convenience, that components having the same functions as those described in the First and Sixth Embodiments are given the same reference numerals, and explanations thereof are omitted here.

The coordinate information detection-type input device 48 according to the present embodiment is provided with both a voice-output feedback function of the coordinate information detection-type input device 45 according to the Fourth Embodiment and a font-display feedback function of the coordinate information detection-type input device 47 according to the Sixth Embodiment. For this purpose, as shown in FIG. 11, the coordinate information detection-type input device 48 is provided with a local feedback section 41 and further provided with a by-product data signal output section 42 serving as output means from the local feedback section 41.

The local feedback section 41 is provided with the font conversion section 14, the font memory 14a, and the display section 3, as well as the character recognition section 23, the voice synthesis section 25, and the sound producing section 6. A video signal supplied from the touch panel 5 is converted into a character code by the character recognition section 23, and then converted into a voice by the voice synthesis section 25 so that a voice is outputted as a feedback from the sound producing section 6. Also, supply of the character code to the font conversion section 14 allows for displaying a font on the display section 3 as feedback with respect to a handwritten input on the touch panel 5.

This makes it possible for a user to check a voice and a font display for accuracy of an input on the spot upon inputting, thereby making it possible to check for accuracy of an input more effectively than checking of only one of a voice and a font display.

In addition, the by-product data signal output section 42 provided in the coordinate information detection-type input device 48 includes a character code output section 16, a second video signal output section 18, and an audio signal output section 19 so as to output out of the coordinate information detection-type input device 48 a character code generated by the local feedback section 41, a video signal realized by font data, and an audio signal, respectively. Therefore, connection of the character code output section 16, the second video signal output section 18, or the audio signal output section 19 in the by-product data signal output section 42 to an external device allows for output of a character code, a video signal realized by font data, and an audio signal as a feedback.

Therefore, the coordinate information detection-type input device 48 is not only a coordinate information detection-type input device, but also can be used as a keyboard for outputting a character code, a device such as a rewriting machine for outputting a video signal realized by font data, or a device for outputting a synthetic audio signal. This causes the coordinate information detection-type input device 48 to be a device of high convenience. It is to be noted that, according to the above descriptions, although the by-product data signal output section 42 in the coordinate information detection-type input device 48 includes the character code output section 16, the second video signal output section 18, and the audio signal output section 19, the by-product data signal output section 42 may be provided with only any one or two of those output sections.

The following will describe examples of how the functional sections are disposed and structured in the input devices 1 and 21 according to the First to Seventh Embodiments.

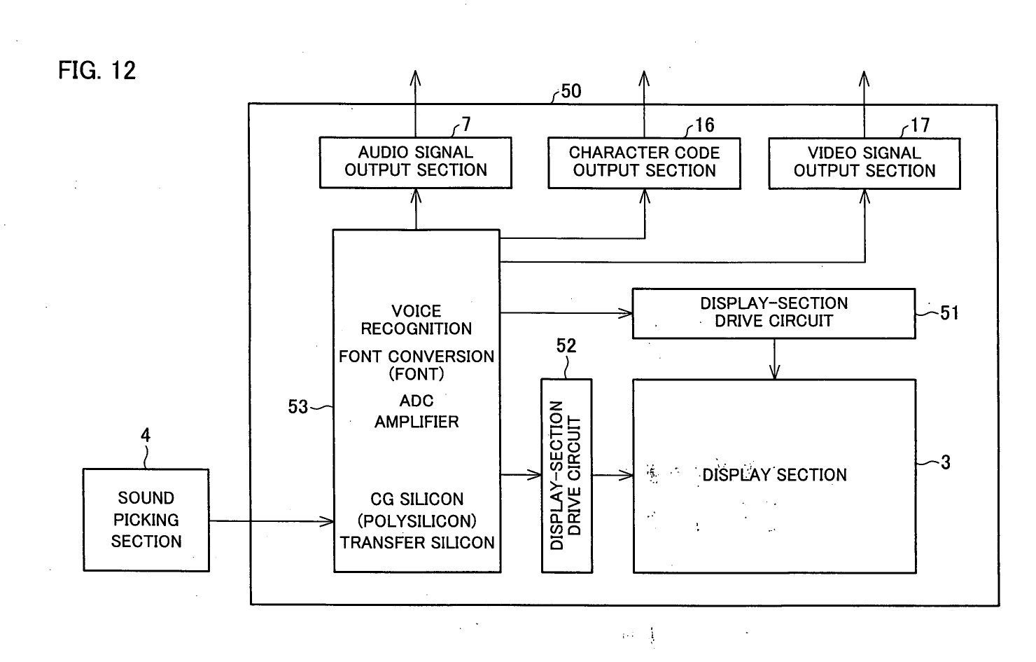

FIG. 12 is a block diagram showing one example of a structure which concretely realizes the microphone device 1 of the First Embodiment shown in FIG. 1. In FIG. 12, reference numeral 50 indicates a substrate which is made of the same glass or the like as the display section 3 is formed of. If a display element constituting the display section 3 is, for example, a liquid crystal panel using liquid crystal, the display element has a substrate disposed opposite to the substrate 50, and liquid crystal is injected into a space therebetween.

The substrate 50 has a thin film layer including a polycrystalline silicon (polysilicon) thin film. Provided in a region of the display section 3 are a pixel electrode and a pixel-driving circuit element (not shown) formed of the thin film layer. Also, provided on the substrate 50 are display-section drive circuits 51 and 52 for driving the display section 3 and a circuit block 53 formed of the thin film layer. The circuit block 53 includes the voice recognition section 13, the font conversion section 14, the amplifier section 11, the analog-digital converter section 12, and others. In addition, the character code output section 16, the video signal output section 17, the audio signal output section 7, and others are also formed of the thin film layer on the substrate 50. The circuit block 53 may include the font memory 14a formed of the thin film layer.

The thin film layer formed on the substrate 50 may be a glass substrate having a thin film layer including continuous grain-boundary crystal silicon (CG silicon) formed thereon, apart from a thin film layer including a polysilicon thin film. Nikkei Electronics (published on Feb. 17, 2003), p. 123-130 describes a technique of forming an 8-bit microprocessor on a glass substrate. As for this microprocessor, a CG-silicon technique is used to form a thin film layer including CG silicon on a glass substrate.

CG silicon has a feature that it has large crystal grains and regular boundaries as compared with general low-temperature polycrystalline silicon. Since CG silicon has a high electron mobility of 200 to 300 cm²/Vs, CG silicon enables high-speed operation of a logical circuit. The use of this technique provides a voice recognition function, realized by a logic processing circuit typified by a microprocessor, to a substrates having liquid crystal sandwiched therebetween.

Moreover, by using a technique of bonding an integrated-circuit active element made of monocrystal silicon, the circuit block 53 including the voice recognition section 13, the font conversion section 14, the amplifier section 11, the analog-digital converter section 12, and others; the character code output section 16; the video signal output section 17; the audio signal output section 7; and others may be provided on a monocrystal-silicon thin film layer bonded onto the substrate 50. It is to be noted that the bonding technique is described, for example, in Japanese Laid-Open Patent Publication No. 17107/1999 (Tokukaihei 11-17107; published on Jan. 22, 1999). Hereinafter, a thin film layer using the bonding technique is referred to as transfer silicon.

Particularly, in a step of bonding an active element formed on a separate substrate onto the substrate 50, a hydrogen ion peeling method is preferably used. In bonding using the hydrogen ion peeling method, the active-element including separate substrate, having a hydrogen ion injection section, is bonded onto the substrate 50 and then heat-treated.

In another method, an adhesive agent is used for bonding a separate substrate having an active element formed thereon to the substrate 50. However, this method suffers from a drawback in that it requires troublesome bonding work and in that the adhesive agent has a problem with its heat resistance, so that only a limited number of steps can be performed after bonding the active element. On the contrary, since the hydrogen ion peeling method dispenses an adhesive agent, there will never be such a drawback.

The following describes an example on how an MOS monocrystal silicon thin film transistor is bonded using the hydrogen ion peeling method. Provided on a surface of a monocrystal silicon substrate serving as a substrate to be bonded are: an oxidized film, forming a portion of the MOS monocrystal silicon thin film transistor; a gate pattern; and an impurity ion injection section. Provided at a predetermined depth from the surface is a hydrogen ion injection section. Such a monocrystal silicon substrate is bonded on the side of the oxidized film to an insulative substrate and is heat-treated. The heat treatment changes the bonding of the two substrates into an atomic bond for a stronger bonding. The heat treatment also causes cleavage exfoliation in the hydrogen ion injection section, thereby removing an unnecessary portion on the monocrystal silicon substrate. This makes it possible to easily bond an MOS monocrystal silicon thin film transistor onto an insulative substrate even without using an adhesive agent.

The bonding by the hydrogen ion peeling method makes it possible to provide the local feedback section 31 and the by-product data signal output section 32 without scale-up of the microphone device 1. In addition, the bonding by the hydrogen ion peeling method realizes formation of the aforesaid circuit sections 31 and 32 on the substrate 50, thereby allowing for cost reduction by a cost for a separate substrate which is not required. Such an arrangement, solving a problem with exfoliation or the like due to vibration of the bond part of an independent circuit component such as an IC, contributes to lowering loss of electric power and improving reliability. An arrangement is of course possible in which some of the above-described circuits in the circuit block 53 are formed on the thin film layer of the substrate 50 and others on an external substrate.

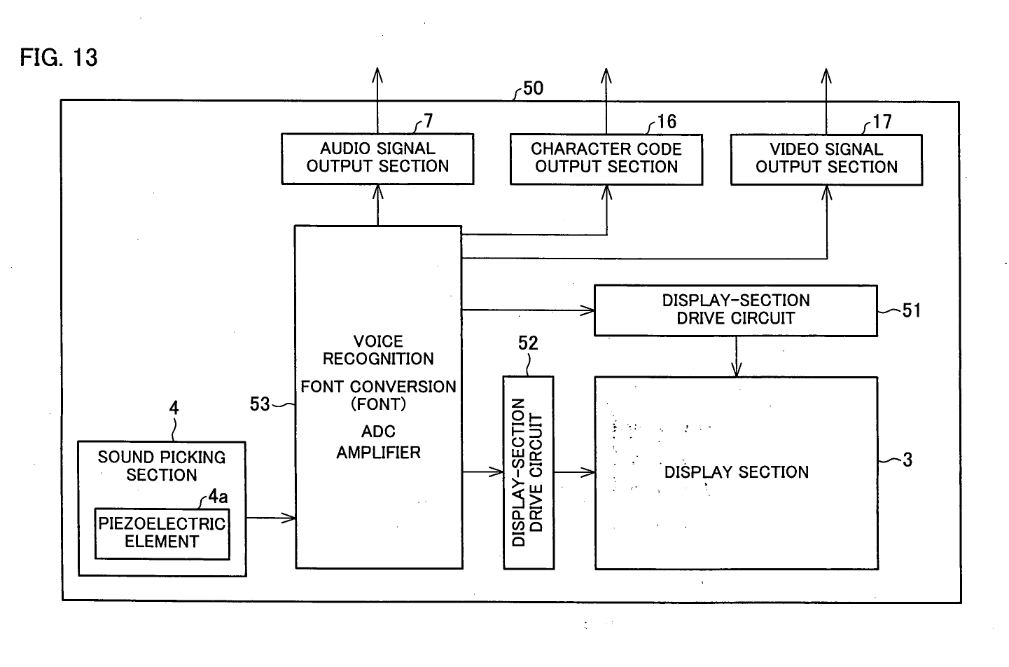

In FIG. 12, the sound picking section 4, not provided on the substrate 50, is arranged separately from the display section 3. However, as shown in FIG. 13, the sound picking section 4, using a piezoelectric element 4a which is formed of a thin plate made of, for example, Rochelle-salt crystal or ceramic, may be provided on the substrate 50 or bonded to the substrate 50 for integration. That is, supposing that the sound picking section 4 is constituted of a vibration section, which is vibrated by a voice, and a pick-up section (pick-up circuit) for converting vibration of the vibration section into an electrical signal, the vibration section is the substrate 50, and the pick-up section is the piezoelectric element 4a. Vibration of the substrate 50 by voice is converted into an electrical signal by the piezoelectric element 4a, and the electrical signal is supplied into the voice recognition section 13 and the like.

In such an arrangement, since the substrate 50 having the display section 3 thereon is used as a vibration section, the display element constituting the display section 3 becomes a display element with a built-in microphone circuit. This arrangement makes the microphone device 1 smaller in shape than an arrangement in which the sound picking section 4 and the display section 3 are independent from each other.

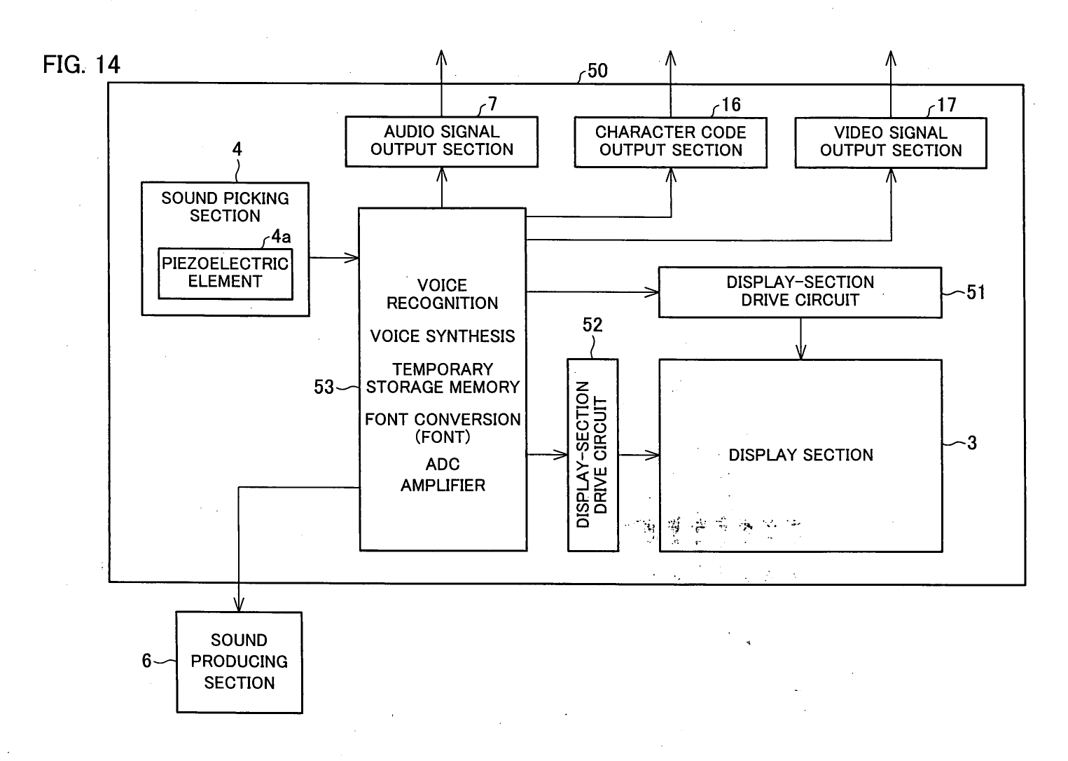

FIGS. 14 to 16 are image diagrams showing one example of a structure of the microphone device 21 according to the Second Embodiment shown in FIG. 6. It is to be noted, for the sake of convenience, that components having the same functions as those described with reference to FIGS. 12 and 13 are given the same reference numerals, and explanations thereof are omitted here.

Provided on the substrate 50 are: the display-section drive circuits 51 and 52; the circuit block 53 including the voice recognition section 13, the font conversion section 14, the temporary storage memory 27, the amplifier section 11, and the analog-digital converter section 12; the character code section 16; the video signal output section 17; the audio signal output section 7; and others, all of which are formed of a thin film layer (polysilicon, CG silicon, and transfer silicon), as in the above arrangement.

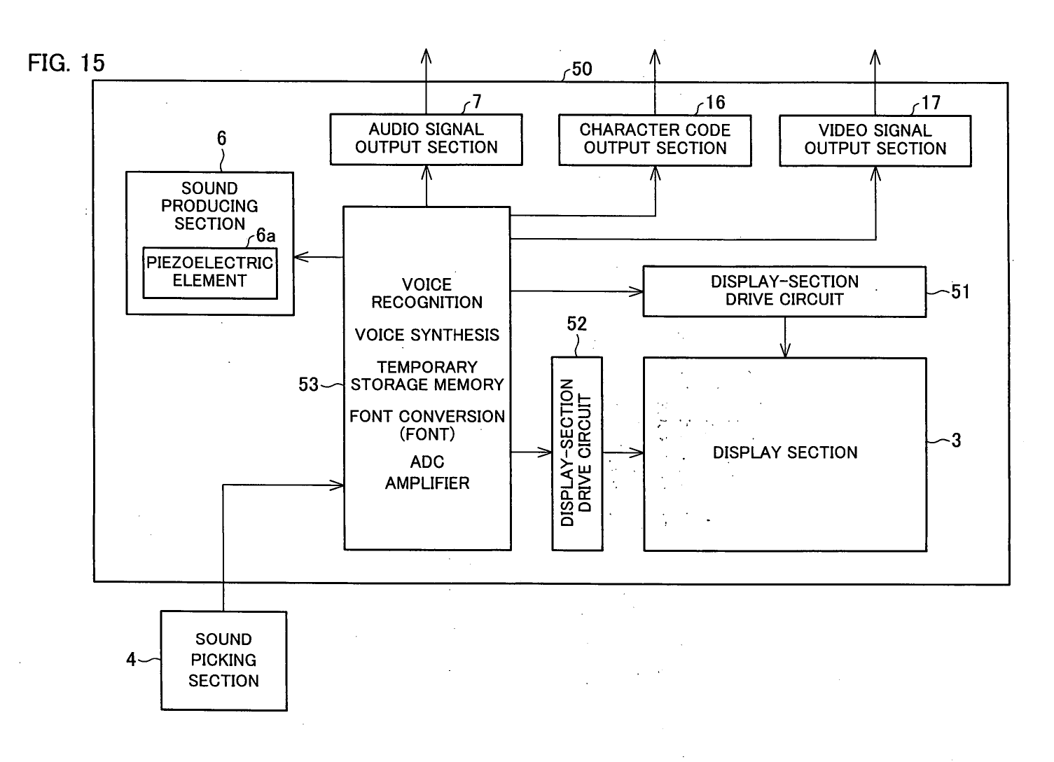

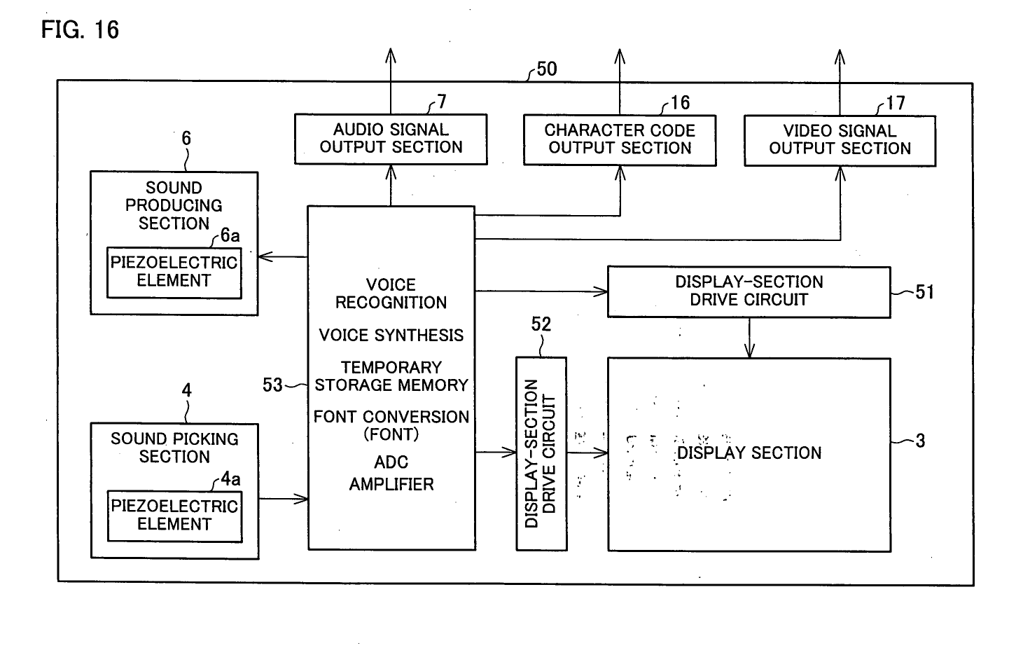

FIG. 14 shows an arrangement in which the sound picking section 4 is provided onto the substrate 50 which functions as a vibration section for the sound picking section 4, and the sound producing section 6 is provided outside of the substrate 50. On the contrary, FIG. 15 shows an arrangement in which the sound producing section 6 is provided onto the substrate 50 which functions as a vibration section for the sound producing section 6, and the sound picking section 4 is provided outside of the substrate 50. FIG. 16 shows an arrangement in which both the sound picking section 4 and the sound producing section 6 are provided onto the substrate 50 which functions as a vibration section for both the sound picking section 4 and the sound producing section 6.

It is to be noted that when the microphone device 22 according to the Third Embodiment shown in FIG. 7 is applied to the arrangements of FIGS. 14 to 16, an arrangement of the microphone device 22 is identical with the arrangements of FIGS. 14 to 16 except that the echo cancellation circuit 28 is provided instead of the temporary storage memory 27. In a similar manner as described above, the echo cancellation circuit 28 is provided by using a thin film layer (polysilicon, CG silicon, and transfer silicon) formed on the substrate 50.

Thus, an arrangement in which at least any one of the sound picking section 4 and the sound producing section 6 is provided onto the substrate 50 makes an entire device more compact than an arrangement in which the sound picking section 4 and the sound producing section 6 are provided outside of the substrate 50.

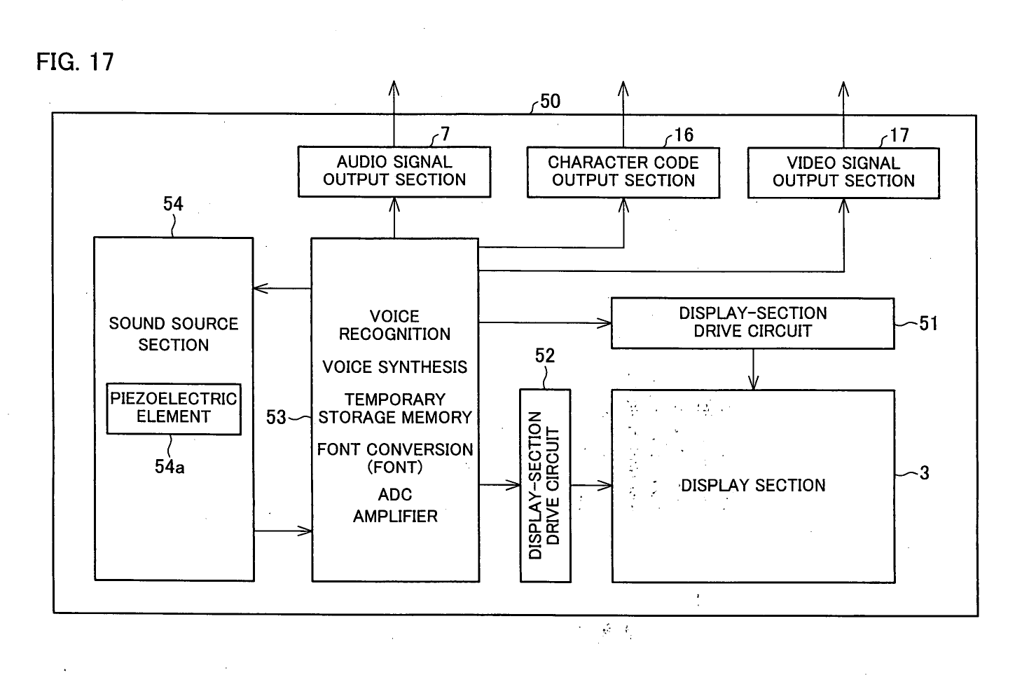

In addition, FIG. 17 is a block diagram showing another example of the structure which concretely realizes the microphone devices 21 and 22 according to the second and Third Embodiments. It is to be noted, for the sake of convenience, that components having the same functions as those described with reference to FIGS. 12 through 16 are given the same reference numerals, and explanations thereof are omitted here.

In the arrangement of FIG. 17, sound picking and sound producing are carried out by a sound source section 54 that is one piezoelectric element 54a, provided on the substrate 50, which is a combination of (i) the piezoelectric element 4a constituting the pick-up section in the sound picking section 4 and (ii) the piezoelectric element 6a constituting an excitation source section in the sound producing section 6. According to this arrangement, vibration of the substrate 50 is converted into an electrical signal by the piezoelectric element 54a constituting the sound source section 54, and the electrical signal is supplied to the voice recognition section 13 and the like. In addition, the sound source section 54 vibrates the substrate 50 based on a drive signal from an audio-section drive circuit provided on an output section of the voice synthesis section 25, thereby generating a voice.

However, in the above arrangement in which the sound source section 54 is shared for the sound picking section 4 and the sound producing section 6 requires, either the temporary storage memory 27 or, as described above, a PTT switch, a VOX circuit, or the like for simplex operation needs to be provided. The PTT switch and the VOX circuit, as in the above arrangement, can be provided by using a thin film layer (polysilicon, CG silicon, and transfer silicon) formed on the substrate 50.

It is to be noted that although description is not done in reference to a schematic block diagram, a reverse arrangement of FIG. 17, i.e. an arrangement in which neither the sound picking section 4 nor the sound producing section 6 are provided onto the substrate 50 and their own vibration sections are separated from the substrate 50.

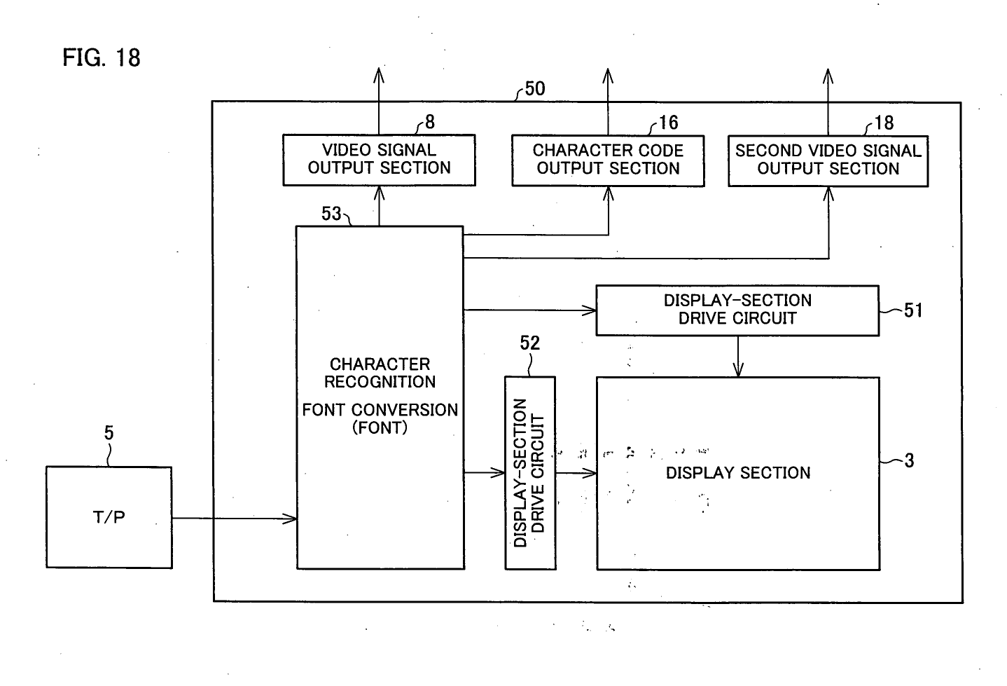

In addition, FIG. 18 is a block diagram showing one example of a structure which concretely realizes the coordinate information detection-type input device 47 according to the Sixth Embodiment shown in FIG. 10. It is to be noted, for the sake of convenience, that components having the same functions as those described with reference to FIGS. 12 through 17 are given the same reference numerals, and explanations thereof are omitted here.

Provided on the substrate 50 are: the display-section drive circuits 51 and 52; the circuit block 53 including the character recognition section 23, the font conversion section 14, and others; the character code section 16; the video signal output section 8; the second video signal output section 18; and others, all of which are formed of a thin film layer (polysilicon, CG silicon, and transfer silicon), as in the above arrangement.

The Sixth Embodiment exemplifies an arrangement in which the touch panel 5 includes an electrical signal processing circuit for converting an electrical signal that is information on coordinates corresponding to the content of an input, into a video signal so as to output the video signal. However, the electrical signal processing circuit may be provided on the substrate 50, not on the touch panel 5, using a thin film layer (polysilicon, CG silicon, and transfer silicon) as is the case with the character recognition section 23 and others.

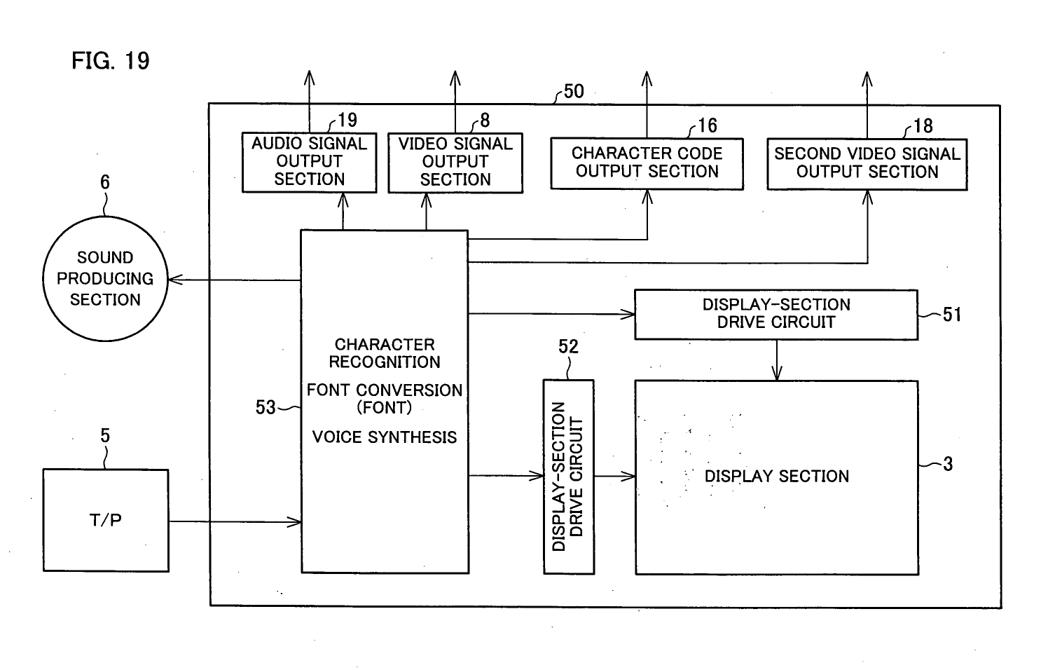

In addition, FIG. 19 is a block diagram showing one example of a structure which concretely realizes the coordinate information detection-type input device 48 according to the Seventh embodiment shown in FIG. 11. It is to be noted, for the sake of convenience, that components having the same functions as those described with reference to FIGS. 12 through 18 are given the same reference numerals, and explanations thereof are omitted here.

Provided on the substrate 50 are: the display-section drive circuits 51 and 52; the circuit block 53 including the character recognition section 23, the font conversion section 14, the voice synthesis section 25, and others; the character code section 16, the video signal output section 8, the second video signal output section 18; the audio signal output section 19; and others, all of which are formed of a thin film layer (polysilicon, CG silicon, and transfer silicon), as in the above arrangement.

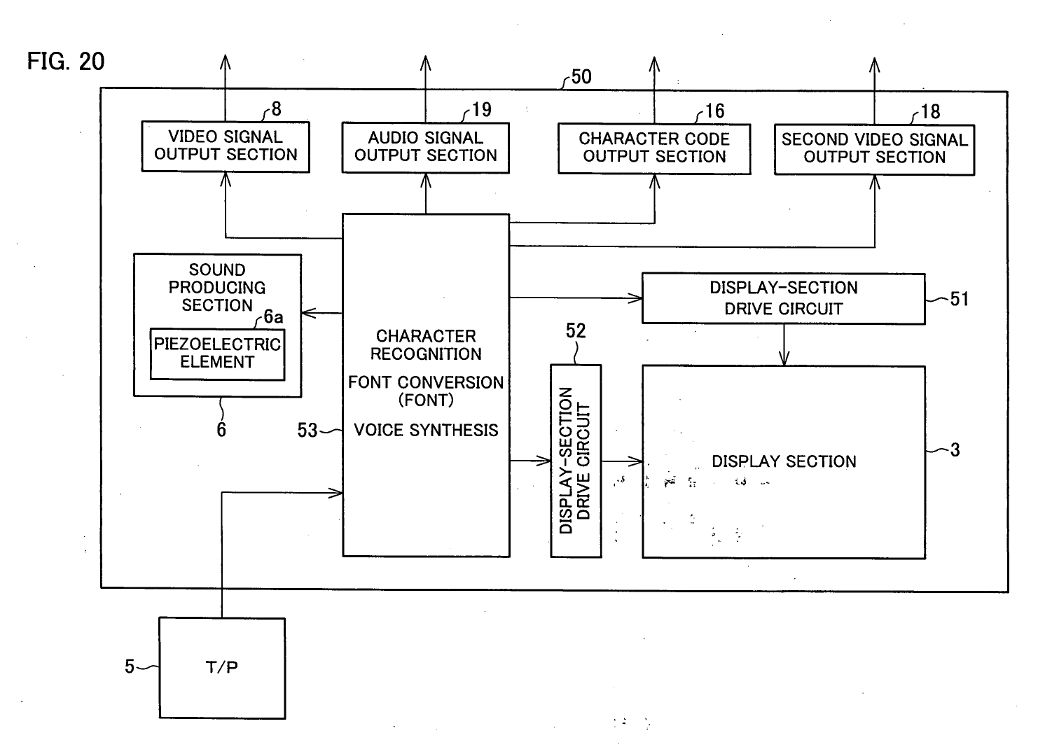

In FIG. 19, the sound producing section 6, not provided on the substrate 50, is provided independently of the display section 3. However, as shown in FIG. 20, the sound producing section 6, using a piezoelectric element 6a which is formed of a thin plate made of, for example, Rochelle-salt crystal or ceramic, may be provided on the substrate 50. That is, supposing that the sound producing section 6 is constituted of a vibration section, which is vibrated by a voice, and an excitation source section, which vibrates the vibration section according to an audio signal supplied from an voice synthesis circuit; the vibration section is constituted of the substrate 50, and the excitation source section is constituted of the piezoelectric element 6a.

In an arrangement in which the sound producing section 6 is incorporated into a display element constituting the display section 3, an audio-section drive circuit for driving an excitation source section constituted of a piezoelectric element 6a is provided on an output section of the voice synthesis section 25, and the excitation source section vibrates the substrate 50 based on a drive signal from the audio-section drive circuit, thereby generating a voice. The audio-section drive circuit, as in the above-described arrangement, can also be provided by using a thin film layer (polysilicon, CG silicon, and transfer silicon) formed on the substrate 50.

In such an arrangement, since the substrate 50 is used as a vibration section, the display element constituting the display section 3 becomes a display element with a built-in sound source. Therefore, such an arrangement makes it possible to make coordinate information detection-type input devices 33 and 34 equipped with a display section and a speaker, smaller in shape than an arrangement in which the sound producing section 6 is constituted separately from the display section 3.

It is to be noted, although not particularly shown, that when the coordinate information detection-type input device 46 according to the Fifth Embodiment of FIG. 9 is applied to the arrangements of FIGS. 19 and 20, an arrangement of the coordinate information detection-type input device 46 (not shown) is identical with the arrangements of FIGS. 19 and 20 except that the circuit block 53 is not provided with the font conversion section 14 and the font memory 14a, and the second video signal output section 18 is not provided on the substrate 50.

All the above embodiments exemplifies an arrangement in which each input device includes a glass substrate and an electric circuit (voice recognition circuit, voice synthesizing circuit, display-section drive circuit, and others), constituted of an element such as CG silicon, which is provided thereon. However, the present invention, not limited to this arrangement, includes an arrangement in which each input device includes a glass substrate and an optical arithmetic circuit provided thereon, instead of an electric circuit. The optical arithmetic circuit, constituted of an optical arithmetic element such as an optical control FET and an optical switch, performs operation by selectively forming an optical path. In addition, the present invention includes an arrangement in which each input device includes a glass substrate and an organic arithmetic circuit provided thereon, apart from. an optical arithmetic circuit. The organic arithmetic circuit is formed of an organic arithmetic element utilizing a molecule activity.

In the following, the embodiments are recapitulated.

A first input device is an input device for supplying a signal corresponding to input information, which is inputted from an input section, from a signal output section to an external device connected to the input device,

the input device including:

local feedback section for feeding back the input information so as to provide a display or output of a voice.

According to this arrangement, the input information inputted from the input section is not only converted into an electrical signal or the like so as to be sent to the external device, but also is fed back by the local feedback section so as to be provided as a display or output of a voice. This enables a user to see the display or hear the voice so as to check the input information upon inputting.

Therefore, even when an electrical signal cannot be normally sent to the external device due to, for example, input in a low voice in case of a voice input, it becomes possible to grasp the situation on the spot. Improving an input condition by, for example, speaking louder makes it possible to input information reliably and perform input operation at ease all the time. From the presence or absence of a feedback signal (a signal as a feedback derived from input information), it can be judged whether the input device is normally operating. This also serves as a self-check of the function when the input device is the above-mentioned thin client connected at all times to the host.

A second input device is an input device, provided with a sound picking section for picking a voice so as to convert the voice into an electrical signal, for supplying a signal corresponding to input information, which is inputted by voice from the sound picking section, from a signal output section to a first external device connected to the input device,

the input device including:

local feedback section for feeding back the input information so as to provide a display.

According to this arrangement, in an input device such as microphone device which enables input of information voice from the sound picking section and converts the input information into an electrical signal (audio signal) so as to send the electrical signal to the first external device, the input information inputted by voice is fed back by the local feedback section so as to be provided as a display. Therefore, as in the above arrangement, the user can check the input information upon inputting.

Moreover, at the time of input by voice, a display provided as a feedback on the basis of input information is checked with eyes, which are sense organs irrelevant to sound. Therefore, as compared with checking of output by voice for accuracy of the input by voice in the ears, which are sense organs relevant to sound, the checking with eyes becomes easier for a user to perceive feedback information, thereby enabling more effective checking.

A third input device is an input device, provided with a sound picking section for picking a voice so as to convert the voice into an electrical signal, for supplying a signal corresponding to input information, which is inputted by voice from the sound picking section, from a signal output section to a first external device connected to the input device, the input device including: a local feedback section for feeding back the input information so as to provide a display and output of a voice.

According to this arrangement, as in the above arrangement, the user can check the input information on the spot upon inputting information. Moreover, as described above, the checking is performed with eyes, which are not directly relevant to inputting information. Therefore, this checking makes it easy for a user to perceive the content of feedback information, thereby enabling more effective checking. In addition, ears are also used for this checking. The use of different types of sense organs enables even more effective checking.

A fourth input device includes the local feedback section of the second input device, the local feedback section for example including: a display section; a voice recognition section for recognizing a voice, converted into an electrical signal by the sound picking section, so as to convert the voice into a character code; and a character conversion section for converting the character code, converted by the voice recognition section, into its corresponding character data, wherein a display is provided on the display section based on the character data converted by the character conversion section. This makes it possible to easily realize an input device for feeding back information inputted by voice so as to provide a display. Also, in this arrangement, adjustment to an algorithm and a parameter applied in the voice recognition section makes it possible to adjust the amount of feedback which becomes a criterion for determination of an input level required in an external device.

A fifth input device includes the local feedback section of the third input device, the local feedback section for example including: a display section; an audio output section; a voice recognition section for recognizing a voice, converted into an electrical signal by the sound picking section, so as to convert the voice into a character code; a character conversion section for converting the character code, converted by the voice recognition section, into its corresponding character data; and a voice synthesis section for converting the character code, converted by the voice recognition section, into its corresponding voice data, wherein a display is provided on the display section on the basis of the character data converted by the character conversion section, and a voice is outputted from the audio output section on the basis of the audio data converted by the voice synthesis section. This makes it possible to easily realize an input device for feeding back information inputted by voice so as to provide a display output and a voice output.

Also, when a voice is outputted as a feedback of information inputted by voice, it is preferable that an output timing adjustment section be provided for adjusting output timing of a voice as a feedback in order to eliminate (i) lowering of a feedback effect due to the outputted voice overlapping a speech of the user and (ii) the risk of howling due to the self loop formation of an audio circuit.

When input of a voice to the sound picking section and output of a voice from the voice output section concurs, the voice emitted from the voice output section, which is an output resulting from the inputted voice that has been picked and then amplified by the amplifier, is picked again. This sometimes leads to a very unpleasant and loud noise due to endless passages through an amplifier circuit and an effect of transmission distortion and delay. This phenomenon is called howling. By thus providing the timing adjustment section which delays timing of a voice outputted as feedback information so that an input and an output do not overlap each other, the above problem can be avoided. In addition, a phenomenon is known that it becomes difficult for the user to speak for a perceptual reason due to a delay of the audio circuit. It is expected that such an echo back environment which is a hindrance to an original input function can also be prevented.

Also, for output of a voice as a feedback of information inputted by voice, the echo cancellation section may be provided for canceling the voice as a feedback out of a voice inputted to the sound picking section. The echo cancellation section also prevents the howling, thereby avoiding the problem as described above.

In addition to the above arrangement, the fifth or a sixth input device may further include a by-product data signal output section for outputting at least one of the character code, the character data, and the voice data, which are respectively generated by the voice recognition section, the character conversion section, and the voice synthesis section in said local feedback section, to a second external device connected to said input device.

According to this arrangement, since the by-product data signal output means outputs at least one of the character code, the character data, and the voice data, which are generated by the local feedback section, connecting the by-product data signal output means to the second external device allows feedback information to be outputted as a character code, a video signal, and an audio signal.

It is to be noted that the second external device may be identical to the first external device and contributes to expansion in application of the external device and improvement on information reliability. Also, the input device does not necessarily need to be connected to the first external device to function and may be connected only to the second external device.

Therefore, such an input device is not only a microphone device and the like which converts a voice into an audio signal so as to output the audio signal, but also can be used as a substitutional device for a keyboard for outputting a character code and an imaging device, such as a scanner and a CCD camera, for outputting a video signal. In addition, the input device can be used also as a device for outputting an audio signal of a synthetic voice. This causes the input device to be a device of high convenience.

The seventh input device is an input device, provided with a coordinate information detection section for detecting a pointed object in contact or standing close so as to sequentially obtain coordinate information on a pointed position, for supplying input information which is inputted by means of the coordinate information detection section, to a first external device connected to said input device, said input device including: a local feedback section for feeding back the input information so as to provide output of a voice.

According to this arrangement, in an input device, such as a coordinate information detection-type input device, provided with a coordinate information detection device which converts input information supplied using the coordinate information detection device into an electrical signal so as to send the electrical signal to the first external device, wherein the input information supplied using the coordinate information detection device is fed back by the local feedback section so as to be outputted as a voice. Therefore, as is the case with the first input device, the user can check the input information on the spot upon inputting.

Moreover, at the time of input using the coordinate information detection section, a voice outputted as a feedback on the basis of input information is checked in the ears, which are sense organs irrelevant to input from the coordinate information detection section. Therefore, this checking allows a user to easily perceive feedback information based on the input from the coordinate information detection section, thereby enabling more effective checking, as compared with checking of a display with eyes, i.e., sense organs relevant to the input.

An eighth input device is an input device, provided with a coordinate information detection section for detecting a pointed object in contact or standing close so as to sequentially obtain coordinate information on a pointed position, for supplying input information which is inputted by means of the coordinate information detection section, to a first external device connected to said input device, said input device including: a local feedback section for feeding back the input information so as to provide output of a voice and a display.

According to this arrangement, as is the case with the seventh input device, the user can check the input information on the spot upon inputting information. Moreover, as described above, the checking is performed in ears, which are not directly relevant to inputting information. Therefore, this checking makes it easy for the user to perceive the content of feedback information, thereby enabling more effective checking In addition, eyes are also used for this checking. The use of different types of sense organs enables even more effective checking.

A ninth input device includes the local feedback section of the seventh input device, the local feedback section including: a voice output section; a character recognition section for recognizing coordinate information, detected by the coordinate information detection section, so as to convert the coordinate information into a character code; and a voice synthesis section for converting the character code, converted by the character recognition section, into its corresponding voice data, wherein a voice is outputted from the voice output section based on the voice data converted by the voice synthesis section. This realizes an input device for feeding back input information inputted to the coordinate information detection section so as to provide output of a voice.

A tenth input device includes the local feedback section of the eighth input device, the local feedback section including, for example: a voice output section; a display section; a character recognition section for performing character recognition with respect to coordinate information, detected by the coordinate information detection section, so as to convert the coordinate information into a character code; a character conversion section for converting the character code, converted by the character recognition section, into its corresponding character data; and a voice synthesis section for converting the character code, converted by the character recognition section, into its corresponding voice data, wherein a voice is outputted from the voice output section based on the voice data converted by the voice synthesis section, and a display is provided based on character data converted by the character conversion section. This realizes an input device for feeding back input information inputted by means of the coordinate information detection section so as to provide output of a voice and a character display.

An eleventh input device includes the local feedback section of the eighth input device, the local feedback section including: a voice output section; a display section; a character recognition section for performing character recognition with respect to coordinate information, detected by the coordinate information detection section, so as to convert the coordinate information into a character code; and a voice synthesis section for converting the character code, converted by the character recognition section, into its corresponding voice data, wherein a voice is outputted from the voice output section based on the voice data converted by the voice synthesis section, and coordinate information detected by the coordinate information detection section is displayed on the display section. This realizes an input device for feeding back input information inputted by means of the coordinate information detection section so as to provide output of a voice and a display of coordinate information, a locus, or the like.

In addition to the above arrangement, the ninth to eleventh input devices may further include a by-product data signal output section for outputting at least one of the character code, the character data, and the voice data, which are respectively generated by the character recognition section, the character conversion section, and the voice synthesis section in said local feedback section, to a second external device connected to said input device.

According to this arrangement, since the by-product data signal output means outputs at least one of the character code, the character data, and the voice data, which are generated by the local feedback section, connecting the by-product data signal output means to the second external device allows feedback information to be outputted as a character code, a video signal, or an audio signal.

It is to be noted that the second external device may be identical to the first external device and contributes to expansion in application of the external device and improvement on information reliability. Also, the input device does not necessarily need to be connected to the first external device to function and may be connected only to the second external device.

Therefore, such input devices are not only a coordinate information detection-type input device or the like for converting information inputted by means of a touch panel into an electrical signal so as to output the electrical signal, but also can be used as a substitutional device for various devices including a keyboard for outputting a character code and an imaging device, such as a scanner and a CCD camera, for outputting a video signal. In addition, the input devices can be used also as a device (e.g., a vocoder or a text voice synthesizer) for outputting an audio signal of a synthetic voice. This causes the input devices to be a device of high convenience.

Further, in the fourth or the fifth input device, (i) part or all of the voice recognition section and the character conversion section; (ii) part or all of the voice recognition section, the character conversion section, and the voice synthesis section; (iii) part or all of the character recognition section, the character conversion section, and the voice synthesis section; (iv) part or all of the voice recognition section, the character conversion section, and the by-product data signal output section; (v) part or all of the voice recognition section, the character conversion section, the voice synthesis section, and the by-product data signal output section; or (vi) part or all of the character recognition section, the character conversion section, the voice synthesis section, and the by-product data signal output section in said local feedback section are provided directly on a thin film substrate or are provided in such a manner that an active element provided on a separate substrate is bonded to the thin film substrate, the thin film substrate constituting a display section and including a pixel-driving circuit element, the active element including the above (i), (ii), (iii), (iv), (v), or (vi).

In addition, one of the ninth to eleventh input devices can also be characterized in that (i) part or all of the character recognition section and the voice synthesis section or (ii) part or all of the character recognition section, the voice synthesis section, and the by-product data signal output section are provided directly on a thin film substrate or are provided in such a manner that an active element provided on a separate substrate is bonded to the thin film substrate, the thin film substrate including a thin film element, and the active element including the above (i) or (ii).

Such an arrangement realizes an input device including the local feedback section or an input device including the by-product data signal output means as well as the local feedback section without drastically changing and increasing an original outer dimension and shape of the input device. In addition, the formation of the relevant circuit section on the same substrate allows for cost reduction to the extent a separate substrate is not required. Such an arrangement, solving a problem with exfoliation or the like due to vibration of the bond part of an independent circuit component such as an IC, contributes to lowering loss of electric power and improvement on reliability and energy savings.

As the thin film substrate, used are a thin film substrate having a thin film layer including a polycrystalline silicon thin film and a thin film substrate having a thin film layer including a continuous grain-boundary crystal silicon thin film.

It is preferable that the bonding of the active element, provided on the separate substrate, to the thin film substrate is performed in such a manner that the separate substrate having a hydrogen ion injection section is bonded to the thin film substrate and then heat-treated.

As compared with bonding of an active element provided on a separate substrate using an adhesive agent, the bonding using the hydrogen ion peeling method in which such a hydrogen ion injection section is provided for peeling, eliminates the need for troublesome bonding work and is excellent in productivity. Also, the bonding using the hydrogen ion peeling method does not use an adhesive agent, thus allowing for easily bonding of an active element provided on a separate substrate without the problem with heat resistance of the adhesive agent.

In addition, in case of input by voice, the sound picking section is composed of a vibration section and a pick-up section for converting vibration of the vibration section into an electrical signal so as to output the electrical signal, and the thin film substrate is the vibration section. An arrangement in which the thin film substrate, which is provided with various circuit components, is used as a vibration section of the sound picking section makes an entire device compact as compared with an arrangement having the vibration section of the sound picking section separately from the thin film substrate.

In addition, in an arrangement including the voice output section, the voice output section is composed of a vibration section and an excitation source section for causing voice data supplied from the voice synthesis section to vibrate the vibration section, and the thin film substrate may be the vibration section. An arrangement in which the thin film substrate, which is provided with various circuit components, is used as a vibration section of the voice output section makes an entire device compact as compared with an arrangement having the vibration section of the voice output section separately from the thin film substrate.

In addition, in an arrangement in which input is performed by voice and the voice output section is included, the thin film substrate may be a common vibration section of the sound picking section and the voice output section. This arrangement makes an entire device compact as compared with an arrangement in which a vibration section of any one of the sound picking section and the voice output section is a thin film substrate.

Particularly, in an arrangement in which the thin film substrate is a common vibration section of the sound picking section and the voice output section, the combination of the pick-up section with the excitation source section makes an entire device more compact.

An input device according to each of the embodiments described above can be utilized for a system and the like which causes a microphone device or a coordinate information detection-type input device as a client device to send input information to a host device provided as an information receiver through a wire, a wireless system, or the like.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. An input device for supplying a signal corresponding to input information, which is inputted from an input section, from a signal output section to an external device connected to said input device,
said input device comprising:
local feedback means for feeding back the input information so as to provide a display or output of a voice.

2. An input device, provided with a sound picking section for picking a voice so as to convert the voice into an electrical signal, for supplying a signal corresponding to input information, which is inputted by voice from the sound picking section, from a signal output section to a first external device connected to said input device,
said input device comprising:
local feedback means for feeding back the input information so as to provide a display.

3. The input device according to claim 2, wherein:
said local feedback means feeds back the input information so as to provide a display and output of a voice.

4. The input device according to claim 2, wherein:
said local feedback means includes:
a voice recognition section for recognizing a voice, converted into an electrical signal by the sound picking section, so as to convert the voice into a character code;
a character conversion section for converting the character code, converted by the voice recognition section, into its corresponding character data; and
a display section for displaying a character based on the character data converted by the character conversion section.

5. The input device according to claim 3, wherein:
said local feedback means includes:
a voice recognition section for recognizing a voice, converted into an electrical signal by the sound picking section, so as to convert the voice into a character code;
a character conversion section for converting the character code, converted by the voice recognition section, into its corresponding character data;
a voice synthesis section for converting the character code, converted by the voice recognition section, into its corresponding voice data;
a display section for displaying a character based on the character data converted by the character conversion section; and
a voice output section for outputting a voice based on the voice data converted by the voice synthesis section.

6. The input device according to claim 3, further comprising:
output timing adjustment means for adjusting output timing of the voice as a feedback.

7. The input device according to claim 3, further comprising
echo cancellation means for canceling the voice as the feedback out of a voice inputted to the sound picking section.

8. The input device according to claim 4, further comprising:
a by-product data signal output section for outputting at least one of the character code, the character data, and the voice data, which are respectively generated by the voice recognition section, the character conversion section, and the voice synthesis section in said local feedback means, to a second external device connected to said input device.

9. The input device according to claim 5, further comprising:
a by-product data signal output section for outputting at least one of the character code, the character data, and the voice data, which are respectively generated by the voice recognition section, the character conversion section, and the voice synthesis section in said local feedback means, to a second external device connected to said input device.

10. An input device, provided with a coordinate information detection section for detecting a pointed object in contact or standing close so as to sequentially obtain coordinate information on a pointed position, for supplying input information which is inputted by means of the coordinate information detection section, to a first external device connected to said input device,
said input device comprising:
local feedback means for feeding back the input information so as to provide output of a voice.

11. The input device according to claim 10, wherein:
said local feedback means feeds back the input information so as to provide output of a voice and a display.

12. The input device according to claim 11, comprising said local feed back means which includes:
a character recognition section for recognizing coordinate information, detected by said coordinate information detection section, so as to convert the coordinate information into a character code;
a voice synthesis section for converting the character code, converted by the character recognition section, into its corresponding voice data; and
a voice output section for outputting a voice based on the voice data converted by the voice synthesis section.

13. The input device according to claim 11, wherein:
said local feed back means includes:
a character recognition section for recognizing coordinate information, detected by said coordinate information detection section, so as to convert the coordinate information into a character code;
a voice synthesis section for converting the character code, converted by the character recognition section, into its corresponding voice data;
a character conversion section for converting the character code, converted by the character recognition section, into its corresponding character data;
the voice output section for outputting a voice based on the voice data converted by the voice synthesis section; and
a display section for displaying a character based on the character data converted by the character conversion section.

14. The input device according to claim 11, wherein:
said local feed back means includes:
a character recognition section for recognizing coordinate information, detected by said coordinate information detection section, so as to convert the coordinate information into a character code;
a voice synthesis section for converting the character code, converted by the character recognition section, into its corresponding voice data;
a voice output section for outputting a voice based on the voice data converted by the voice synthesis section; and
a display section for displaying the coordinate information detected by said coordinate information detection section.

15. The input device according to claim 12, further comprising:
a by-product data signal output section for outputting at least one of the character code, the character data, and the voice data, which are respectively generated by the character recognition section, the character conversion section, and the voice synthesis section in said local feedback means, to a second external device connected to said input device.

16. The input device according to claim 13, further comprising:
a by-product data signal output section for outputting at least one of the character code, the character data, and the voice data, which are respectively generated by the character recognition section, the character conversion section, and the voice synthesis section in said local feedback means, to a second external device connected to said input device.

17. The input device according to claim 14, further comprising:
a by-product data signal output section for outputting at least one of the character code, the character data, the coordinate information, and the voice data, which are respectively generated by the character recognition section, the character conversion section, the coordinate information detection section, and the voice synthesis section in said local feedback means, to a second external device connected to said input device.

18. The input device according to claim 4, wherein:
part or all of the voice recognition section and the character conversion section in said local feedback means are provided directly on a thin film substrate or are provided in such a manner that an active element provided on a separate substrate is bonded to the thin film substrate, the thin film substrate constituting a display section and including a pixel-driving circuit element, the active element including the part or all of the voice recognition section and the character conversion section.

19. The input device according to claim 5, wherein:
part or all of the voice recognition section, the character conversion section, and the voice synthesis section in said local feedback means are provided directly on a thin film substrate or are provided in such a manner that an active element provided on a separate substrate is bonded to the thin film substrate, the thin film substrate constituting a display section and including a pixel-driving circuit element, the active element including the part or all of the voice recognition section, the character conversion section, and the voice synthesis section.

20. The input device according to claim 8, wherein:
(i) part or all of the voice recognition section, the character conversion section, and the by-product data signal output section in said local feedback means or (ii) part or all of the voice recognition section, the character conversion section, the voice synthesis section, and the by-product data signal output section in said local feedback means are provided directly on a thin film substrate or are provided in such a manner that an active element provided on a separate substrate is bonded to the thin film substrate, the thin film substrate constituting a display section and including a pixel-driving circuit element, the active element including the above (i) or (ii).

21. The input device according to claim 9, wherein:
(i) part or all of the voice recognition section, the character conversion section, and the by-product data signal output section in said local feedback means or (ii) part or all of the voice recognition section, the character conversion section, the voice synthesis section, and the by-product data signal output section in said local feedback means are provided directly on a thin film substrate or are provided in such a manner that an active element provided on a separate substrate is bonded to the thin film substrate, the thin film substrate constituting a display section and including a pixel-driving circuit element, the active element including the above (i) or (ii).

22. The input device according to claim 12, wherein:
part or all of the character recognition section and the voice synthesis section in said local feedback means are provided directly on a thin film substrate or are provided in such a manner that an active element provided on a separate substrate is bonded to the thin film substrate, the thin film substrate including a thin film element, the active element including the part or all of the character recognition section and the voice synthesis section.

23. The input device according to claim 14, wherein:
part or all of the character recognition section and the voice synthesis section in said local feedback means are provided directly on a thin film substrate or are provided in such a manner that an active element provided on a separate substrate is bonded to the thin film substrate, the thin film substrate including a thin film element, the active element including the part or all of the character recognition section and the voice synthesis section.

24. The input device according to claim 13, wherein:
part or all of the character recognition section, the character conversion section, and the voice synthesis section in said local feedback means are provided directly on a thin film substrate or are provided in such a manner that an active element provided on a separate substrate is bonded to the thin film substrate, the thin film substrate constituting a display section and including a pixel-driving circuit element, the active element including the part or all of the character recognition section, the character conversion section, and the voice synthesis section.

25. The input device according to claim 15, wherein:
(i) part or all of the character recognition section, the voice synthesis section, and the by-product data signal output section in said local feedback means or (ii) part or all of the character recognition section, the character conversion section, the voice synthesis section, and the by-product data signal output section in said local feedback means are provided directly on a thin film substrate or are provided in such a manner that an active element provided on a separate substrate is bonded to the thin film substrate, the thin film substrate constituting a display section and including a pixel-driving circuit element, the active element including the above (i) or (ii).

26. The input device according to claim 18, wherein:
the thin film substrate has a thin film layer including a polycrystalline silicon thin film.

27. The input device according to claim 19, wherein:
the thin film substrate has a thin film layer including a polycrystalline silicon thin film.

28. The input device according to claim 20, wherein:
the thin film substrate has a thin film layer including a polycrystalline silicon thin film.

29. The input device according to claim 21, wherein:
the thin film substrate has a thin film layer including a polycrystalline silicon thin film.

30. The input device according to claim 22, wherein:
the thin film substrate has a thin film layer including a polycrystalline silicon thin film.

31. The input device according to claim 23, wherein:
the thin film substrate has a thin film layer including a polycrystalline silicon thin film.

32. The input device according to claim 24, wherein:
the thin film substrate has a thin film layer including a polycrystalline silicon thin film.

33. The input device according to claim 18, wherein:
the thin film substrate has a thin film layer including a continuous grain-boundary crystal silicon thin film.

34. The input device according to claim 19, wherein:
the thin film substrate has a thin film layer including a continuous grain-boundary crystal silicon thin film.

35. The input device according to claim 20, wherein:
the thin film substrate has a thin film layer including a continuous grain-boundary crystal silicon thin film.

36. The input device according to claim 21, wherein:
the thin film substrate has a thin film layer including a continuous grain-boundary crystal silicon thin film.

37. The input device according to claim 22, wherein:
the thin film substrate has a thin film layer including a continuous grain-boundary crystal silicon thin film.

38. The input device according to claim 23, wherein:
the thin film substrate has a thin film layer including a continuous grain-boundary crystal silicon thin film.

39. The input device according to claim 24, wherein:
the thin film substrate has a thin film layer including a continuous grain-boundary crystal silicon thin film.

40. The input device according to claim 25, wherein said thin film substrate has a thin film layer including a continuous grain-boundary crystal silicon thin film.

41. The input device according to claim 18, wherein:
the bonding of the active element, provided on the separate substrate, to the thin film substrate is performed in such a manner that the separate substrate having a hydrogen ion injection section is bonded to the thin film substrate and then heat-treated.

42. The input device according to claim 19, wherein:
the bonding of the active element, provided on the separate substrate, to the thin film substrate is performed in such a manner that the separate substrate having a hydrogen ion injection section is bonded to the thin film substrate and then heat-treated.

43. The input device according to claim 20, wherein:
the bonding of the active element, provided on the separate substrate, to the thin film substrate is performed in such a manner that the separate substrate having a hydrogen ion injection section is bonded to the thin film substrate and then heat-treated.

44. The input device according to claim 21, wherein:
the bonding of the active element, provided on the separate substrate, to the thin film substrate is performed in such a manner that the separate substrate having a hydrogen ion injection section is bonded to the thin film substrate and then heat-treated.

45. The input device according to claim 22, wherein:
the bonding of the active element, provided on the separate substrate, to the thin film substrate is performed in such a manner that the separate substrate having a hydrogen ion injection section is bonded to the thin film substrate and then heat-treated.

46. The input device according to claim 23, wherein:
the bonding of the active element, provided on the separate substrate, to the thin film substrate is performed in such a manner that the separate substrate having a hydrogen ion injection section is bonded to the thin film substrate and then heat-treated.

47. The input device according to claim 24, wherein:
the bonding of the active element, provided on the separate substrate, to the thin film substrate is performed in such a manner that the separate substrate having a hydrogen ion injection section is bonded to the thin film substrate and then heat-treated.

48. The input device according to claim 25, wherein:
the bonding of the active element, provided on the separate substrate, to the thin film substrate is performed in such a manner that the separate substrate having a hydrogen ion injection section is bonded to the thin film substrate and then heat-treated.

49. The input device according to claim 18, wherein:
the sound picking section is composed of a vibration section and a pick-up section for converting vibration of the vibration section into an electrical signal so as to output the electrical signal, and the thin film substrate is the vibration section.

50. The input device according to claim 19, wherein:
the sound picking section is composed of a vibration section and a pick-up section for converting vibration of the vibration section into an electrical signal so as to output the electrical signal, and the thin film substrate is the vibration section.

51. The input device according to claim 19, wherein:
the voice output section is composed of a vibration section and an excitation source section for causing voice data supplied from the voice synthesis section to vibrate the vibration section, and the thin film substrate is the vibration section.

52. The input device according to claim 22, wherein:
the voice output section is composed of a vibration section and an excitation source section for causing voice data supplied from the voice synthesis section to vibrate the vibration section, and the thin film substrate is the vibration section.

53. The input device according to claim 23, wherein:
the voice output section is composed of a vibration section and an excitation source section for causing voice data supplied from the voice synthesis section to vibrate the vibration section, and the thin film substrate is the vibration section.

54. The input device according to claim 24, wherein:
the voice output section is composed of a vibration section and an excitation source section for causing voice data supplied from the voice synthesis section to vibrate the vibration section, and the thin film substrate is the vibration section.

55. The input device according to claim 19, wherein:
the sound picking section is composed of a vibration section and a pick-up section for converting vibration of the vibration section into an electrical signal so as to output the electrical signal,
the voice output section is composed of a vibration section and an excitation source section for causing voice data supplied from the voice synthesis section to vibrate the vibration section, and
the thin film substrate is a common vibration section of the sound picking section and the voice output section.

56. The input device according to claim 24, wherein said sound-picking component is constituted of a vibration component and a pick-up component for converting vibration of the vibration component into an electrical signal so as to output the electrical signal, and said voice output component is constituted of a vibration component and an exciting source component for causing voice data from said voice synthesizer to vibrate said vibration component, and said thin film substrate is a common vibration component of said sound-picking component and said voice output component.

57. The input device according to claim 55, wherein:
the pick-up section and the excitation source section are combined.

58. The input device according to claim 56, wherein:
the pick-up section and the excitation source section are combined.
